(19) United States
(12) Patent Application Publication
(10) Pub. No.: US 2025/0154333 A1
(43) Pub. Date: May 15, 2025

(54) RENEWABLE POLYMERS FROM POST-CONSUMER PET DEPOLYMERIZED FEEDSTOCK

(71) Applicant: Rikarbon, Inc., Newark, DE (US)

(72) Inventors: Basudeb Saha, Newark, DE (US); Mahesh Parit, West Lafayette, IN (US)

(73) Assignee: RiKarbon, Inc., Newark, DE (US)

(21) Appl. No.: 18/840,707

(22) PCT Filed: Feb. 22, 2023
(86) PCT No.: PCT/US2023/013631

§ 371 Date: Aug. 22, 2024

Related U.S. Application Data
(60) Provisional application No. 63/312,519, filed on Feb. 22, 2022.
(60) Provisional application No. 63/422,529, filed on Nov. 4, 2022.

(51) Int. Cl. C08J 11/16; C08G 63/08; C08G 63/183; C08G 63/86; C08J 11/14

(52) U.S. Cl. CPC C08J 11/16; C08G 63/08; C08G 63/183; C08G 63/866; C08J 11/14; C08J 2367/03

(57) ABSTRACT

Disclosed herein is a hydrolytic depolymerization of post-consumer polyesters such as polyethylene terephthalate (PET) mixed plastics containing clear PET and colored PET into depolymerized-polyester product including one or more of a depolymerized-polyester monomer product and a depolymerized-polyester oligomer product. Also, disclosed herein is the polymerization of the depolymerized-polyester oligomer product to renewable polymers. The hydrolytic depolymerized-polyester product containing terminal hydroxyl and carboxyl functional groups can be used as a building block feedstock to produce fully renewable polyester and renewable copolymers with caprolactone, a caprolactone-based oligomer, a caprolactone-based polymer, or mixtures thereof.

### CROSS-REFERENCE TO RELATED APPLICATION

This application claims priority to U.S. Provisional Patent Application No. 63/312,519, filed Feb. 22, 2022 and U.S. Provisional Patent Application No. 63/422,529, filed Nov. 4, 2022, the disclosures of each of these applications being incorporated herein by reference in their entireties for all purposes.

### STATEMENT REGARDING FEDERALLY SPONSORED RESEARCH

This invention was made with government support under Grant No. DE-SC0020939 awarded by the Department of Energy. The government has certain rights in the invention.

### BACKGROUND OF THE INVENTION

Polyethylene terephthalate (PET) plastics are currently produced by polymerization of petroleum-derived terephthalic acid (TPA) and ethylene glycol (EG). This process currently produces about 33 million tons of PET and other polyester plastics. The process is estimated to release ˜2.8 kg CO₂ eq/kg of PET. The majority of this plastic is discarded to the environment as a waste after the end-use of the final plastic made consumer goods, e.g., water bottle, soft drink containers, fibers, textiles etc. Uncontrolled and unregulated release of this waste, which is non-degradable, creates environmental hazard. It is estimated that about 10% of this discarded waste ends up in the ocean and water body. Slow photo-degradation of plastics, caused by weathering and biological processes, forms micro-sized (1 μm-1 mm) and nano-sized (<1 μm) pieces and creates waterborne persistent bioaccumulative toxic chemicals such as bisphenol A (BPA), polycyclic aromatic hydrocarbons (PAHs), polychlorinated biphenyls (PCBs), polybrominated diphenyl ethers (PBDEs) and other toxins into the ocean environment. These small plastic particles are increasingly consumed by marine life that confuses them with food sources. This affects marine organisms, habitats, ecosystems and biogeochemical cycling, as well as poses significant health risks to terrestrial animals, human and economics. For example, the U.S. National Research Council reported that debris, a vast majority of which is plastics according to the report of the International Union for Conservation of Nature Resources (IUCN), causes (1) injury, trapping or drowning of marine life via entanglement (mainly by plastic rope, net and other components), (2) accumulation in their gut through ingestion, and (3) damaging or clogging grills.

Because weathering and biofouling processes continually alter the plastics surface in ways that increase the affinity for leached ocean water toxins sorption, accumulation of chemicals onto plastic debris is projected to increase over time; thus, potentially rendering them more hazardous to marine animals that ingest debris and gradually transmit it to humans through the food chain.

The challenges of waste plastics in the environment and ocean water, creating health hazards to ocean life and humans, and increasing sustainable feedstock demand for chemical enterprises can be simultaneously addressed by selective recycling of waste plastics. Waste mixed plastics are currently sorted by optical machinery at waste management facilities and graded on the basis of commercial value. For example, PET plastic is currently recycled through mechanical processing, which has the following disadvantages.
It causes a significant loss in the properties of plastics (lower ductility, diminished molecular weight and reduced mechanical strength) and the recycled plastics are shredded, melted and molded into lower value products for packaging, building & construction and other applications, which is often referred to as ‘carbon downcycling’.
Because the material properties of used plastics have been already degraded when recycled to produce lower value products, the later materials cannot be recycled again upon their use and hence discarded.

In contrast, selective depolymerization or breakdown of post-consumer PET into PET's building block chemicals and the polymerization of the building block can produce renewable PET with similar quality and properties as the virgin PET. Chemical breakdown of waste PET plastic via alcoholysis, glycolysis, hydrolysis, methanolysis, aminolysis and other methods have been reported. For example, a small fraction of post-consumer PET is commercially broken down by glycolysis and methanolysis process. These processes utilize petroleum-derived solvent such as ethylene glycol by employing reasonably high temperature (>200° C.). Additionally, the separation of the derived product by crystallization is energy-intensive.

Hence, there is a need for new depolymerization processes that operate under milder processing temperature (˜150° C.) and have easier catalyst separation using simple techniques such as filtration instead of energy intensive distillation.

### SUMMARY OF THE INVENTION

Depolymerized-polyester oligomers produced from the depolymerization process as disclosed herein is a potential versatile precursor for further modification and synthesis of various commercial polymers. These oligomers have both alcohol and acidic end groups which enable a wide array of polymer synthesis schemes including, but not limited to, renewable polyester. For example, the depolymerized-polyester oligomer product of the present disclosure can be utilized as an initiator for ring-opening polymerization of various monomers, such as caprolactone, which can be used to make, for example, PET-co-caprolactone copolymers (using depolarized-PET oligomeric product) that can be utilized as compatibilizers in polymer blends. Additionally, polycondensation can be performed with a wide variety of materials to create novel polymeric materials. An example of such polycondensation is the reaction between PET and poly(tetramethylene oxide) which can result in the creation of versatile multi-blocks segmented poly(ether-ester)s such as poly(ethylene terephthalate-co-1,4-cyclohexanedimethylene terephthalate)-block-poly(tetramethylene oxide) which has highly controlled melt and mechanical properties. Further modification of the PET oligomers can be achieved by initially reacting them with an excess quantity of ethylene glycol under polycondensation conditions to convert the precursor into di-alcohol endcap product. This can subsequently be reacted with isothiocyanates to form PET-polyurethanes in which case the PET behaves as a chain extender in the stepwise reaction. Similarly, reaction with diglycidyl compounds can be used for the preparation of epoxies. Conversely, reaction with excess terephthalic acid can convert into a diacid form. This can subsequently be reacted with diamines in a polycondensation condition to form polyamides. The potential applications for the versatile precursor, the depolymerized-polyester oligomer product of the present invention, are diverse and hold great promise for further development.

In an aspect of the present invention, there is provided a process for depolymerizing a polyester comprising the steps of contacting the polyester with an aqueous metal salt solution to form a reaction mixture and heating the reaction mixture to at least 100° C. for an amount of time sufficient to depolymerize at least a portion of the polyester to a depolymerized-polyester product, wherein the depolymerized-polyester product comprises one or more of a depolymerized-polyester monomer product and a depolymerized-polyester oligomer product, and wherein the aqueous metal salt solution comprises from about 20% to about 90% by weight of at least one of ZnBr₂ and ZnI₂, based on the total amount of the reaction mixture.

In an embodiment, the polyester comprises at least one of polyethylene terephthalate, polytrimethylene terephthalate, polybutylene terephthalate, polybutylene adipate terephthalate, polyethylene furanoate, polytrimethylene furanoate, polybutylene furanoate, polycarbonate, polyglycolic acid, polylactic acid, poly-2-hydroxy butyrate, polyhydroxyalkanoate, poly(3-hydroxybutyrate-co-3-hydroxyvalerate), polycaprolactone, and polybutylene succinate. In another embodiment, the polyester comprises clear polyethylene terephthalate, colored polyethylene terephthalate, mixed polyethylene terephthalate, or mixtures thereof. In an embodiment, the polyester is clear ocean-borne polyethylene terephthalate, colored ocean-borne polyethylene terephthalate, mixed ocean-borne polyethylene terephthalate, clear river-borne polyethylene terephthalate, colored river-borne polyethylene terephthalate, mixed river-borne polyethylene terephthalate, clear lake-borne polyethylene terephthalate, colored lake-borne polyethylene terephthalate, mixed lake-borne polyethylene terephthalate, clear landfill-borne polyethylene terephthalate, colored landfill-borne polyethylene terephthalate, mixed landfill-borne polyethylene terephthalate or mixtures thereof. In one embodiment, the polyester is a PET bottle, a PET film, a PET fiber, a PET fabric, a PET flexible packaging, a PET substrate, a PET article containing a metal layer, or mixtures thereof. In another embodiment, the polyester is in particulate form having an average particle size in a range of from about 5 μm to about 100 mm.

In an embodiment of the process, the aqueous metal salt solution comprises ocean water. In another embodiment, the aqueous metal salt solution further comprises one or more of ZnCl₂ and MgBr₂.

In an embodiment of the process, the step of heating the reaction mixture is carried out at a temperature range of from about 100° C. to about 250° C., or from about 140° C. to about 180° C. In yet another embodiment, the step of heating the reaction mixture is carried out for about 1 hour to about 15 hours.

In yet another embodiment, the depolymerized-polyester oligomer product comprises one or more oligomers having a molecular weight of greater than 166 Da, or greater than 200 Da, or in a range of 166 to 3000 Da. In another embodiment, the depolymerized-polyester oligomer product comprises one or more oligomers having a glass transition temperature of greater than 15° C.

In another aspect of the present invention, there is provided a composition comprising one or more of depolymerized-polyester monomer product and depolymerized-polyester oligomer product, obtained from the process as disclosed hereinabove, and a residual metal salt, wherein the metal salt comprises at least one of ZnBr₂ and ZnI₂.

In another aspect of the invention, there is provided a process for producing renewable polyester comprising the steps of contacting the depolymerized-polyester product prepared according to the embodiments of the process for depolymerizing a polyester disclosed hereinabove, with a catalyst and an optional alkylene glycol, to form a polymerization feed mixture, wherein the depolymerized-polyester product comprises one or more of depolymerized-polyester monomer product and depolymerized-polyester oligomer product; polymerizing the polymerization feed mixture by esterification and subsequent polycondensation at a temperature of at least 100° C., optionally in the presence of an inert gas, to produce the renewable polyester; and removing a residual volatile organic compound, optionally in the presence of the inert gas, wherein the residual volatile organic compound comprises one or more of depolymerized-polyester monomers and the optional alkylene glycol, and wherein the polymerization feed mixture comprises from about 30% to about 95% by weight of depolymerized-polyester product, from about 5% to about 60% by weight of the monomer, and less than 0.4% by weight of the catalyst, based on the total amount of the polymerization feed mixture.

In an embodiment of the process for producing renewable polyester, the catalyst comprises antimony (III) oxide, titanium (IV) butoxide, germanium oxide, zinc acetate, or mixtures thereof, and the step of polymerizing is carried out under an inert gas.

In another embodiment, the step of polymerizing is carried out at a temperature in a range of from about 100° C. to about 350° C., or from about 200° C. to about 320° C., and for about 1 hour to about 20 hours. In another embodiment, the step of polymerizing comprises heating the polymerization feed mixture stage-wise, including a first stage from about 1 hour to about 7 hours at a temperature in the range of from about 100° C. to about 320° C. and a second stage from about 1 hour to about 13 hours at a temperature in the range of from about 250° C. to about 350° C.

In an embodiment, the step of removing the residual volatile organic compound is carried out under vacuum. In another embodiment, the step of polymerizing is carried out under vacuum for in situ removal of the residual volatile organic compound.

In an embodiment of the process for producing renewable polyester, the renewable polyester comprises a renewable polyethylene terephthalate and the alkylene glycol comprises ethylene glycol.

In another embodiment, the renewable polyester has a glass transition temperature in the range from about 40° C. to about 85° C. and an intrinsic viscosity in the range from about 0.1 dL/g to about 0.8 dL/g.

In another aspect of the present invention, there is provided a process for producing a renewable copolymer comprising the steps of contacting the depolymerized-polyester product prepared according to the embodiments of the process for depolymerizing a polyester disclosed hereinabove, with a comonomer, and with an optional alkylene glycol, to form a copolymerization feed mixture, wherein the comonomer comprises caprolactone, a caprolactone-based oligomer, a caprolactone-based polymer, or mixtures thereof; heating the copolymerization feed mixture to at least about 100° C. in the presence of a ring-opening polymerization catalyst and a catalyst to form the renewable copolymer; and removing one or more copolymer-residual volatile organic compounds optionally in the presence of an inert gas, wherein the one or more copolymer-residual volatile organic compounds comprises caprolactone, a caprolactone-based oligomer, the optional alkylene glycol, or mixtures thereof, and wherein the copolymerization feed mixture comprises from about 0.1% to about 95% by weight of the depolymerized-polyester product, from about 10% to about 90% by weight of the comonomer, from about 0% to about 20% by weight of the optional alkylene glycol, less than about 2% by weight of the catalyst, and less than about 2% by weight of ring-opening polymerization catalyst, based on the total amount of the copolymerization feed mixture.

In an embodiment of the process for producing a renewable copolymer, the ring-opening polymerization catalyst comprises tin (II) octoate, aluminum alkoxides, zinc oxide, 1,5,7-triazabicyclo [4.4.0] dec-5-ene, 1,8-triazabicyclo [5.4.0]-undec-7-ene, or mixtures thereof, and the catalyst comprises antimony (III) oxide, titanium (IV) butoxide, germanium oxide, zinc acetate, or mixtures thereof.

In another embodiment, the step of heating the copolymerization feed mixture is carried out at a temperature in the range of from about 100° C. to about 320° C., and for about 1 hour to about 20 hours. In another embodiment, the step of heating the copolymerization feed mixture is carried out stage-wise, including a first stage from about 1 hour to about 7 hours at a temperature in the range of from about 100° C. to about 250° C. and a second stage from about 1 hour to about 13 hours at a temperature in the range of from about 200° C. to about 320° C. In an embodiment, the step of heating the copolymerization feed mixture is carried out optionally under the inert gas. In another embodiment, the step of removing the copolymer-residual volatile organic compound is carried out under vacuum.

In an embodiment, the copolymerization feed mixture further comprises polyethylene terephthalate. In another embodiment, the comonomer further comprises butyrolactone, valerolactone, or mixtures thereof.

In an embodiment, the renewable copolymer has at least one of the following properties: (i) peel adhesion failure temperature of at least 20° C., as measured according to a modified ASTM 4498 method, and (ii) a shear adhesion failure temperature of at least 25° C., as measured according to ASTM 4498 method.

In another embodiment, the renewable copolymer is a transparent or semi-transparent adhesive.

In an aspect of the present invention, there is provided an adhesive comprising a renewable copolymer obtained from the process as disclosed hereinabove, wherein the adhesive comprises a transparent or semi-transparent renewable copolymer. In an embodiment, there is provided a hot melt adhesive comprising a renewable copolymer obtained from the process as disclosed hereinabove, wherein the renewable copolymer is a semi-liquid at a hot melt temperature and solidifies at room temperature. In another embodiment, there is provided a pressure sensitive adhesive comprising a renewable copolymer obtained from the process as disclosed hereinabove, wherein the renewable copolymer is semi-liquid at room temperature.

In another aspect of the present invention, there is provided a composition comprising at least one of the renewable polyester and the renewable copolymer, obtained from the embodiments of the processes disclosed hereinabove, and a residual metal salt comprising at least one of ZnBr₂ and ZnI₂.

In yet another aspect, there is provided a process for producing renewable polyamides, polyurethanes, epoxy polymers, ring-opening polymers using the depolymerized-polyester product prepared according to process disclosed hereinabove as a feedstock.

### BRIEF DESCRIPTION OF THE DRAWINGS

FIG. 1A shows an image of clear PET pieces having a size of 2 cm×2 cm; FIGS. 1B-1D shows images of clear PET pieces after completely ground and passed through sieves to obtain 200 μm, 500 μm, and 1 mm size particles. Scanning Electron Microscopy (SEM) analysis revealed that the particle sizes of 500 μm and 200 μm batches varied in the range of about 383-580 μm and about 70-268 μm, respectively.

FIG. 2A shows experimental and post-reaction product recovery and analysis methodologies. FIG. 2B depicts the FTIR spectrum of PET particles having 500 μm size. FIG. 2C depicts the FTIR spectrum of depolymerized PET (white solid) particles of 500 μm. FIG. 2D depicts the FTIR spectrum of mono-methyl terephthalate. A comparison of FIGS. 2C and 2D shows that the depolymerized PET (white solid) is terephthalic acid (TPA).

FIG. 3A shows the SEM image of PET particles having sizes in the range of 383-580 μm. FIG. 3B shows the SEM image of a solid depolymerized-polyester product obtained from the depolymerization of PET particles shown in FIG. 3A. Red index indicates smaller particles and blue index shows aggregated particles. Image shown in FIG. 3B is 5 times more magnified than the Image shown in FIG. 3A.

FIG. 4A Ocean PET collected from Maldives/Dominican Republic and FIG. 4B shows the clear PET flakes after hot washing the Ocean-borne PET of FIG. 4A. FIG. 4C shows the depolymerization results of three different sizes of PET feed and the yields of TPA. The depolymerization reaction was conducted in a 500 ml stainless steel reactor under constant stirring and temperature (156° C.) for 6 hour using 70% aqueous solution of ZnBr₂ as the reaction medium.

FIG. 5 shows that by tuning reaction conditions of the depolymerization reaction, one can produce either (a) terephthalic acid or (b) depolymerized-PET oligomer product from ocean-borne PET flakes.

FIGS. 6A-6E shows Ocean PET from (A) Maldives/Dominican Republic, (B) Kalimo beach, (C) Kalimo beach water, (D) Kalimo beach walkway and (E) control PET. These PET samples were processed to flakes or cut into small pieces, which are shown below the image of their original PET.

FIG. 7 provides a comparison of ocean PET depolymerization in ocean water and DI water under three different conditions: (1) 500 μm clear PET particles for 1 hour reaction, (2) clear PET flakes (average size of about 2 cm×2 cm) depolymerization for 2 hour reaction and (3) clear PET flakes depolymerization for 3.5 hour reaction. Reaction temperature and PET weight of all reactions are 160° C. and 0.5 g, respectively. The reaction medium contained 70% ZnBr₂ (ratio of PET/ZnBr₂ (w/w)=14).

FIGS. 8A-8C show depolymerization yields of Ocean-borne PET flakes under various reaction conditions. (8A) Variation of reaction time using 0.7 g PET flakes in 70% ZnBr₂ reaction medium at 150° C. (8B) Variation of ZnBr₂ concentration in the reaction medium using 1.4 g PET flakes at 150° C. for 6 hour. (8C) The effect of reaction temperature using 1.4 g PET flakes for 5 hour in 70% ZnBr₂ reaction medium.

FIG. 9 shows images of PET feedstock from various sources.

FIG. 10 shows the percentage of degree of polymerization (DP) for various PET feedstocks at 160° C., 50% ZnBr₂, 1300 RPM and 7 hours reaction time. (except PET film which were depolymerized at 160° C., 21.2% ZnBr₂, 1300 RPM and 7 hours) Unfilled bars represent depolymerized-PET oligomer product of particle size ≤700 μm of which particle sizes ≤105 μm (shown by filled bars) are the major fractions.

FIG. 11 shows images of depolymerized-polyester products from different feedstocks.

FIG. 12 shows a DSC thermogram of a depolymerized-PET product.

FIG. 13 shows a gel permeation chromatography (GPC) plot for the depolymerized-PST oligomer product.

FIG. 14 shows clear PET flakes depolymerization at three different temperatures in 70 wt % of ZnBr₂.

FIGS. 15A-15B shows clear PET flakes depolymerization at three different ZnBr₂ concentrations in water using 95 g-120 g PET feedstock for 7 hours. (15A) Percentage of depolymerization and products of different particle sizes. (15B) Water soluble (mostly EG) and DMSO soluble (mostly TPA) products. The reactions were conducted at 160° C.

FIGS. 16A-16B show clear PET flakes depolymerization for 5 and 7 hours in 70 wt % of ZnBr₂ aqueous using 120 g-190 g PET feedstock at 160° C. (16A) Percentage of depolymerization and products of different particle sizes. (16B) Water soluble (mostly EG) and DMSO soluble (mostly TPA) products.

FIG. 17A show recyclability of 50 wt % of ZnBr₂ solution in depolymerization of PET feedstock (clear PET flakes) at 160° C., 1300 RPM, 10 hrs. ˜500 g PET was used in each cycle. FIG. 17B shows ethylene glycol concentration in the recovered 50% ZnBr₂ solutions.

FIG. 18 shows acid number analysis of TPA esterified at various temperatures.

FIG. 19 shows PET formation using polycondensation of esterified TPA.

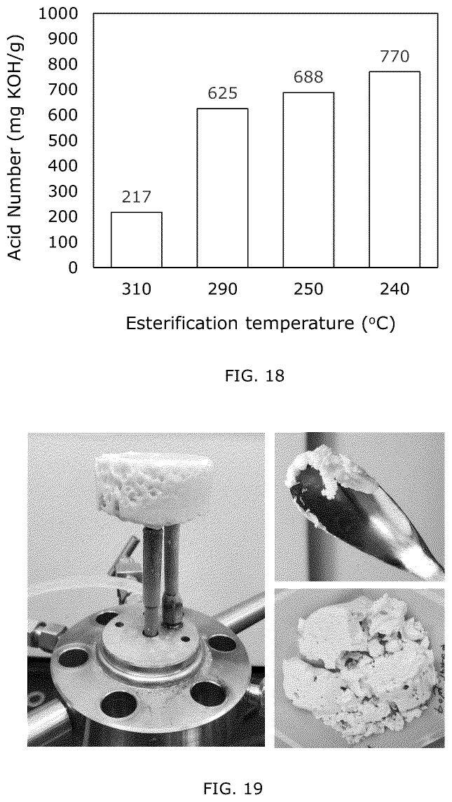

FIGS. 20A-20B show PET samples pictures (20A) R10 (20B) R9.

### DETAILED DESCRIPTION OF THE INVENTION

As used herein, the term “renewable polyester” refers to a polyester comprising recycled post-consumer polyester. The renewable polyester may comprise any suitable amount of the recycled post-consumer polyester, such as for example at least 50 wt %, or 60 wt %, 60 wt %, or 80 wt % or 90 wt %, or 100 wt %. Hence, for example, the term “renewable polyethylene terephthalate (PET)” refers to a polyester made from using any suitable amount of recycled post-consumer PET, such as that obtained from clear ocean-borne polyethylene terephthalate, colored ocean-borne polyethylene terephthalate, mixed ocean-borne polyethylene terephthalate, clear river-borne polyethylene terephthalate, colored river-borne polyethylene terephthalate, mixed river-borne polyethylene terephthalate, clear lake-borne polyethylene terephthalate, colored lake-borne polyethylene terephthalate, mixed lake-borne polyethylene terephthalate, clear landfill-borne polyethylene terephthalate, colored landfill-borne polyethylene terephthalate, mixed landfill-borne polyethylene terephthalate or mixtures thereof.

As used herein, the term “ocean-borne PET” refers to PET recovered from an ocean; the term “river-borne PET” refers to PET recovered from a river; the term “lake-borne PET” refers to PET recovered from a lake; and the term “landfill-borne PET” refers to PET recovered from a landfill. The PET recovered from an ocean, a lake, a river, or a landfill maybe in any suitable form, including but not limited to a PET bottle, a PET film, a PET fiber, a PET fabric, a PET flexible packaging, a PET substrate, a PET article containing a metal layer, or mixtures thereof.

As used herein the term “mixed PET” refers to any PET containing other material, such as a polymer other than PET, a metal, an inorganic material, etc. For example, mixed PET may refer to multilayer packaging such specialty bottles where PET sandwiches additional layer such as PVOH to reduce oxygen permeability; PET packaging with cap, lid, and/or label formed of different polymers; PET used in tape applications, such as the carrier for magnetic tape or backing for pressure-sensitive adhesive tapes; PET used as substrate in thin film devices such as solar cell; PET films comprising a thin layer of metal, such as Mylar®.

As used herein the term “colored PET” refers to any PET comprising a colorant, thereby resulting in the PET having a transparent or opaque colored hue. As used herein the term “clear PET” refers to any transparent PET containing no colorant.

In an aspect of the invention, disclosed herein is a process for depolymerizing a polyester. The process comprises the steps of contacting the polyester with an aqueous metal salt solution to form a reaction mixture and heating the reaction mixture to at least about 100° C. for an amount of time sufficient to depolymerize at least a portion of the polyester to a depolymerized-polyester product. The depolymerized-polyester product may comprise one or more of a depolymerized-polyester monomer product and a depolymerized-polyester oligomer product.

The aqueous metal salt solution may comprise from about 20%, or about 25%, or about 30%, or about 40%, or about 50%, or about 60%, or about 75% to about 90%, or about 80%, or about 70%, or about 65%, or about 55%, or about 45%, or about 35%, by weight of at least one of ZnBr₂ and ZnI₂, based on the total amount of the reaction mixture. In an embodiment, the aqueous metal salt solution comprises ocean water. The ocean water may be present in any suitable amount, such as, about 5%, or about 10%, or about 25%, or about 50%, or about 70%, or 1 about 00%, by weight based on the total amount of water present in the reaction mixture. In an embodiment, the aqueous metal salt solution may further include additional metal salts, including, but not limited to, ZnCl₂, MgBr₂, or mixtures thereof. The additional metal salts may be present in any suitable amount in the metal salt solution. In an embodiment, the additional metal salts may be present in an amount less than the total amount of ZnBr₂ and/or ZnI₂ present in the metal salt solution. In another embodiment, the additional metal salt may be present in an amount of about 0.1-99.9%, or about 1-75%, or about 5-50% by weight based the total amount of ZnBr₂ and/or ZnI₂ present in the metal salt solution.

In an embodiment of the process for depolymerizing a polyester, the step of heating the reaction mixture may be carried out at a temperature range of from about 100° C. to about 250° C., or about 140° C. to about 225° C., or about 130° C. to about 200° C., or about 140° C. to about 180° C. The step of heating the reaction mixture may be carried out for any suitable amount of time sufficient to depolymerize the polyester, such as, from about 1 hour to about 15 hours, or from 1.5 hours to 10 hours, or from 2 hours to 5 hours. However, it should be noted that the heating time will depend upon the amount and composition of catalyst used, and the heating temperature.

Any suitable polyester may be depolymerized by the disclosed process. Exemplary polyesters include, but are not limited to, polyethylene terephthalate (PET), polytrimethylene terephthalate, polybutylene terephthalate, polybutylene adipate terephthalate, polyethylene furanoate, polytrimethylene furanoate, polybutylene furanoate, polycarbonate, polyglycolic acid, polylactic acid, poly-2-hydroxy butyrate, polyhydroxyalkanoate, poly(3-hydroxybutyrate-co-3-hydroxyvalerate), polycaprolactone, polybutylene succinate, and mixtures thereof.

In an embodiment, the step of contacting the polyester comprises contacting clear PET, colored PET, mixed PET, or mixtures thereof. The PET may be a clear ocean-borne PET, colored ocean-borne PET, mixed ocean-borne PET, clear river-borne PET, colored river-borne PET, mixed river-borne PET, clear lake-borne PET, colored lake-borne PET, mixed lake-borne PET, clear landfill-borne PET, colored landfill-borne PET, mixed landfill-borne PET, or mixtures thereof. The clear, colored, or mixed polyester obtained from ocean, river, lake, or landfill, maybe in any suitable form, including, but not limited to, a PET bottle, a PET film, a PET fiber, a PET fabric, a PET flexible packaging, a PET substrate, a PET article containing a metal layer, or mixtures thereof.

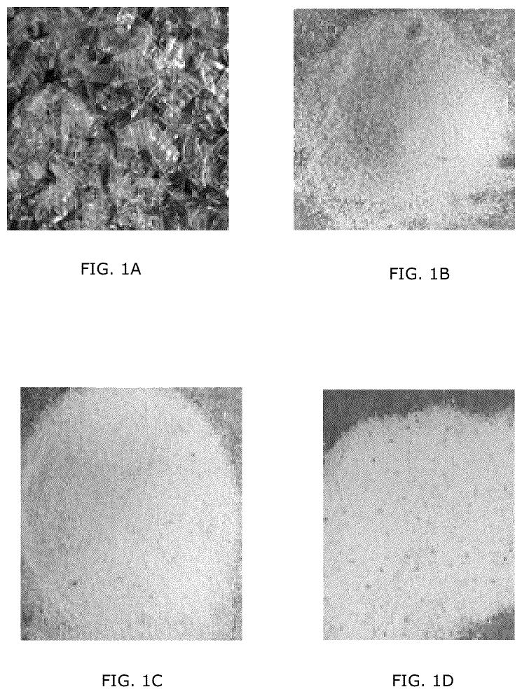

In an embodiment of the process for depolymerizing a polyester, the polyester may be coarsely ground into flakes or particulates, as shown in FIGS. 1A-1D. In an embodiment, the polyester flakes may have an average size of about 1 cm, or about 2 cm, or about 3 cm, or about 4 cm, or about 5 cm, or about 7.5 cm, or about 8 cm, or about 9 cm, or about 10 cm, or about 15 cm, or about 25 cm, or about 50 cm. The polyester flake can have any suitable shape, such as irregular, rectangular, square, round, oval, etc. In an embodiment, the polyester flakes may have an average size of about 3 cm×about 3 cm, or about 2 cm×about 2 cm, or about 1 cm×about 1 cm. In another embodiment, the polyester in a particulate form may have an average particle size in a range of from about 2 μm, or about 3 μm, or about 4 μm, or about 5 μm to about 100 mm or about 50 mm, or about 25 mm, or about 20 mm, or 1 about 0 mm, or about 5 mm, or about 1 mm.

In an embodiment, the process for depolymerizing a polyester comprises depolymerizing PET and the depolymerized-polyester product comprises one or more of a depolymerized-PET monomer product and a depolymerized-PET oligomer product. The depolymerized-PET monomer product may include ethylene glycol and/or terephthalic acid. The depolymerized-PET oligomer product may include one or more oligomers of PET. In an embodiment, the one or more oligomers may have a molecular weight of greater than or equal to about 150 DA, or about 166 Da, or about 200 Da, about 210 Da, or about 254 Da, or about 338 Da, or about 506 Da, or about 639 Da, or about 789 Da, or about 933 Da, or about 977 Da, about 1500 Da, or about 2000 Da, or about 2500 Da, or about 3000 Da, or about 3500 Da, or about 5000 Da, and less than about 5000 Da, or about 4000 Da, or about 3700 Da, or about 3000 Da, or about 2700 Da, or about 1500 Da, or about 1200 Da, or about 1000 Da, or about 750 Da. In an embodiment, the one or more oligomers has a molecular weight in a range of 166 to 3000 Da. In an embodiment, the depolymerized-polyester oligomer product comprises one or more oligomers having a glass transition temperature of greater than about 10° C., or about 15° C., or about 20° C.

In an aspect of the invention, a composition comprises one or more of depolymerized-polyester monomer product and depolymerized-polyester oligomer product, obtained from the process as disclosed hereinabove, and a residual metal salt, wherein the metal salt comprises at least one of ZnBr₂ and ZnI₂. The residual metal salt may be present in less than about 2 ppm, or about 5 ppm, or about 10 ppm, but greater than about 0.01 ppm, or about 0.05 ppm, or about 1 ppm.

In another aspect of the present invention, there is a process for producing a renewable polyester using the depolymerized-polyester product prepared using the process disclosed hereinabove. The process may include contacting the depolymerized-polyester product with a catalyst and an optional alkylene glycol, to form a polymerization feed mixture. The depolymerized-polyester product may comprise one or more of depolymerized-polyester monomer product and depolymerized-polyester oligomer product. The process also includes polymerizing the polymerization feed mixture by esterification and subsequent polycondensation at a temperature of at least 100° C., optionally in the presence of an inert gas, to produce the renewable polyester. The process may further include removing a residual volatile organic compound, optionally in the presence of the inert gas. The residual volatile organic compound may include one or more depolymerized-polyester monomers, the optional alkylene glycol, or mixtures thereof.

In an embodiment, the polymerization feed mixture may include greater than about 30%, or about 35%, or about 40%, or about 45% and less than about 70%, or about 75%, or about 80%, or about 95% by weight of the depolymerized-polyester product; greater than about 5% or about 10%, or about 15% and less than or about 40%, or about 50%, or about 60% by weight of the monomer and less than about 0.5% or about 0.4%, about 0.3% and greater than about 0.05%, or 0.1%, or 0.2% by weight of the catalyst, based on the total amount of the polymerization feed mixture.

Any suitable catalyst may be used, including, but not limited to, antimony (III) oxide, titanium (IV) butoxide, germanium oxide, zinc acetate, and mixtures thereof.

In an embodiment of the process, the step of polymerizing is carried out under an inert gas. Any suitable inert gas may be used, including, but not limited to nitrogen, argon, helium. In another embodiment, the step of polymerizing is carried out under vacuum for in situ removal of the residual volatile organic compound during polymerization. The step of polymerizing is carried out at a temperature in a range of from about 100° C. to about 350° C., or about 180° C. to about 320° C., or about 150° C. to about 310° C., or about 200° C. to about 300° C., or about 240° C. to about 295° C. The step of polymerizing the polymerization feed mixture may be carried out for any suitable amount of time, such from about 1 hour to about 20 hours, or from 1.5 hours to 15 hours, or from 2 hours to 10 hours. In another embodiment, heating the polymerization feed mixture is carried out stage-wise, including a first stage from about 1 hour to about 7 hours at a temperature in the range of from about 150° C. to about 320° C. or from about 200° C. to about 320° C., and a second stage from about 1 hour to about 13 hours at a temperature in the range of from about 250° C. to about 350° C. or from about 250° C. to about 320° C. In an embodiment, the first stage is carried out under the inert gas and the second stage heating is carried out under vacuum to in situ remove residual volatile organic compound. However, it should be noted that the polymerization time in one step reaction or stage-wise will depend upon the amount and composition of catalyst used, and the heating temperature.

In an embodiment, the step of removing the residual volatile organic compound is carried out under vacuum.

In an embodiment, the renewable polyester has a glass transition temperature in the range from about 40° C. to about 95° C., or about 40° C. to about 85° C., or about 50° C. to about 80° C. and an intrinsic viscosity in the range from about 0.1 dL/g to about 0.8 dL/g, or about 0.12 dL/g to about 0.7 dL/g, or about 0.14 dL/g to about 0.6 dL/g.

In an aspect, the renewable polyester is a renewable PET and the alkylene glycol is ethylene glycol. In another embodiment, the renewable PET has the renewable polyester has a glass transition temperature in the range from about 40° C. to about 85° C. and an intrinsic viscosity in the range from about 0.1 dL/g to about 0.8 dL/g.

In another aspect, there is a process for producing a renewable copolymer using the depolymerized-polyester product prepared according to the process disclosed hereinabove. The process comprises contacting the depolymerized-polyester product with a comonomer, and with an optional alkylene glycol, to form a copolymerization feed mixture. In an embodiment, the comonomer may include caprolactone, a caprolactone-based oligomer, a caprolactone-based polymer, or mixtures thereof. The process also includes heating the copolymerization feed mixture to at least about 150° C. in the presence of a ring-opening polymerization catalyst and a catalyst to form the renewable copolymer and removing one or more copolymer-residual volatile organic compounds. The one or more copolymer-residual volatile organic compounds may include caprolactone, a caprolactone-based oligomer, the optional alkylene glycol, or mixtures thereof.

The copolymerization feed mixture may include from greater than about 0.1%, or about 10%, or about 25%, or about 50%, or about 80% or about 90% and less than about 95% by weight of the depolymerized-polyester product; from about 10% to about 90% greater than about 10% or about 15%, or about 20% and less than or about 50%, or about 75%, or about 90% by weight of the comonomer; from about 0%, or about 0.1%, or 1% to less than about 5%, or 10%, or 20% by weight of the optional alkylene glycol; less than about 2%, or about 1.5%, or about 1.0% and greater than about 0.05%, or 0.1%, or 0.5% by weight of the catalyst; and less than about 2%, or about 1.5%, or about 1.0% and greater than about 0.05%, or 0.1%, or 0.5% by weight of ring-opening polymerization catalyst, based on the total amount of the copolymerization feed mixture.

In an embodiment, the comonomer may further include one or more of butyrolactone and valerolactone. In another embodiment, at one of the one or more of butyrolactone and valerolactone is bio-derived, i.e. sourced from plants.

Any suitable ring-opening polymerization catalyst may be used, including, but not limited to, tin (II) octoate, aluminum alkoxides, zinc oxide, 1,5,7-triazabicyclo [4.4.0] dec-5-ene, 1,8-triazabicyclo [5.4.0]-undec-7-ene, or mixtures thereof. Any suitable other catalyst maybe used, including, but not limited to, antimony (III) oxide, titanium (IV) butoxide, a germanium oxide-zinc acetate, or mixtures thereof.

In an embodiment of the process, the step of heating the copolymerization feed mixture is carried out under an inert gas, as disclosed hereinabove. In another embodiment, the step of heating the copolymerization feed mixture is carried out under vacuum for in situ removal of the copolymer-residual volatile organic compound during copolymerization. The step of heating the copolymerization feed mixture may be carried out at a temperature in a range of from about 100° C. to about 320° C., or about 150° C. to about 300° C., or about 200° C. to about 290° C. The step of heating the copolymerization feed mixture may be carried out for any suitable amount of time, such about 1 hour to about 20 hours, or from 1.5 hours to 15 hours, or from 2 hours to 10 hours. In another embodiment, heating the copolymerization feed mixture is carried out stage-wise, including a first stage from about 1 hour to about 7 hours at a temperature in the range of from about 100° C. to about 250° C. or 150° C. to about 250° C. and a second stage from about 1 hour to about 13 hours at a temperature in the range of from about 200° C. to about 320° C. or from about 200° C. to about 300° C. In an embodiment, the first stage is carried out under the inert gas and the second stage heating is carried out under vacuum to in situ remove the copolymer-residual volatile organic compound. However, it should be noted that the copolymerization time in one step reaction or stage-wise will depend upon the amount and composition of catalyst used, and the heating temperature.

In an embodiment, the step of removing the copolymer-residual volatile organic compound is carried out under vacuum.

In an embodiment, the renewable copolymer can be used as an adhesive, a hot melt adhesive, or a pressure sensitive adhesive. In an embodiment, the renewable copolymer is used as a transparent or semi-transparent adhesive. In another embodiment, the renewable copolymer has a peel adhesion failure temperature (PAFT) of at least about 20° C., or about 23° C., or about 25° C., or about 30° C., or about 50° C., as measured according to a modified ASTM 4498 method. In yet another embodiment, the renewable copolymer has a shear adhesion failure temperature (SAFT) of at least about 25° C., or about 28° C., or about 30° C., or about 35° C., or about 50° C.,, as measured according to ASTM 4498 method.

In an aspect of the present invention, there is provided an adhesive comprising a renewable copolymer obtained from the process as disclosed hereinabove, wherein the adhesive comprises a transparent or semi-transparent renewable copolymer. In an embodiment, there is provided a hot melt adhesive comprising a renewable copolymer obtained from the process as disclosed hereinabove, wherein the renewable copolymer is a semi-liquid at a hot melt temperature and solidifies at room temperature. In another embodiment, there is provided a pressure sensitive adhesive comprising a renewable copolymer obtained from the process as disclosed hereinabove, wherein the renewable copolymer is semi-liquid at room temperature.

In an aspect of the present invention, there is a composition including at least one of the renewable polyester and the renewable copolymer, as disclosed hereinabove; and a residual metal salt comprising at least one of ZnBr₂ and ZnI₂.

In another aspect, there is a process for producing renewable polyamides, polyurethanes, epoxy polymers, ring-opening polymers using the depolymerized-polyester product, as disclosed hereinabove, as a feedstock.

To summarize, the present invention discloses a novel and innovative process to hydrolytically depolymerize post-consumer PET to PET's building block oligomeric/monomeric product, referred hereto as depolymerized-polyester product including a depolymerized-polyester monomer product and a depolymerized-polyester oligomer product, and the use of the depolymerized-polyester oligomers as a feedstock to produce new polymers. The process to depolymerize a wide range of post-consumer PET feedstock such as clear PET, color PET, PETG, mixed PET, mixed plastics, pre-process PET flakes, un-processed PET machine cut flakes, ocean-borne PET, river-borne PET, lake-borne PET, or landfill-borne PET is disclosed. The scalability of the depolymerization process of the present invention demonstrated in a 5 L pressure reactor, characterization of produced depolymerized-polyester oligomer product and polymerization of depolymerized-polyester oligomers to upcycled PET and adhesive polymers are disclosed herein. The depolymerization reaction conditions in terms of reactant ratios, catalyst concentration, type, temperature, and time were varied which are described in the Example Nos. 1 to 10. The depolymerized-polyester oligomer product was characterized by thermal, chromatographic, and titrimetric methods. Specifically, the depolymerized-polyester oligomer product was characterized to determine the functional groups (hydroxyl, carboxylic), molecular weight fractions, glass transition temperature (T_{g}), melting temperature (Tₘ).

Depolymerized-polyester oligomer product was used to produce two different types of polymers. In one case, the depolymerized-polyester oligomer product was polymerized in a 250 mL metallic reactor to produce renewable PET using esterification and polycondensation steps. Depolymerized-polyester oligomer product derived from various feedstocks were tested for PET synthesis. The polymerization reaction conditions in terms of reactant ratios, catalyst concentration, type, temperature, and time were varied as described in the examples 1B to 7B. The renewable PET samples were characterized by thermal, chromatographic and viscometric methods. Specifically, the renewable PET samples were characterized to determine their intrinsic viscosity (IV), glass transition temperature (T_{g}), melting temperature (Tₘ). In another case, Depolymerized-polyester oligomer product was polymerized with different amounts of caprolactone to produce co-polymers that have adhesive characteristic. Various compositions were used to produce hot melt or pressure sensitive type of the adhesive copolymers. The polymerization reaction conditions in terms of reactant ratios, reactant type were varied as described in the examples 1 to 7. These adhesive copolymer samples were characterized by thermal, chromatographic, viscometric, and adhesion testing methods. Specifically, the copolymer samples were characterized to determine their glass transition temperature (Tg), molecular weight, intrinsic viscosity (IV), Mettler softening point, peel adhesion failure temperature (PAFT), shear adhesion failure temperature (SAFT).

As used herein, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. As used herein, the term “about” means within ±4% of the stated value, or within ±3.5% of the stated value, or within ±3% of the stated value, or within ±2% of the stated value, preferably within ±2% of the stated value, more preferably within ±1% of the stated value. The term “room temperature” when used herein, is intended to refer to a temperature of about 20° C. to about 25° C. It is not intended that the scope of the invention be limited to the specific values recited when defining a range.

Within this specification, embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

In some embodiments, the invention herein can be construed as excluding any element or process step that does not materially affect the basic and novel characteristics of the compositions or processes. Additionally, in some embodiments, the invention can be construed as excluding any element or process step not specified herein.

### EXAMPLES

Examples of the present invention will now be described. The technical scope of the present invention is not limited to the examples described below.

### Abbreviations

PET—Polyethylene terephthalate
TPA—Terephthalic acid
EG—Ethylene glycol
PETG—Polyethylene terephthalate glycol
DMSO—Dimethyl sulfoxide
IV—Intrinsic viscosity

### Materials

Materials and their source are listed below:

All chemicals except caprolactone and ZnBr₂ were purchased from the VWR International. Caprolactone and ZnBr₂ were purchased from the Fischer Scientific and Beantown Chemical Corporation, respectively.

### Methods

### Titrimetric Analysis

Hydroxyl content of the depolymerized-polyester product was estimated using reflux phthalation method described in ASTM D 4274-99. Briefly, the 1.5 gm depolymerized-polyester oligomer product was dissolved in 25 mL of the phthalic anhydride pyridine reagent into each flask. Then the flask was introduced to the oil batch maintained at 115° C. for 1 hr. The depolymerized powder was allowed to react with the phthalic anhydride during this time. The unreacted phthalic anhydride was then titrated against 0.5 N NaOH solution in presence of phenolphthalein indicator to a pink end point that persists for at least 15 s. Hydroxyl number was then estimated as follows

$$Hydroxyl number = [ ( B - A ) \times N \times 56.1 ] / W$$

where:
A=NaOH required for titration of the sample, mL,
B=NaOH required for titration of the blank, mL,
N=normality of the NaOH, and
W=sample used, g.

Carboxyl content measurement was estimated using the ASTM D4662-08. Briefly, 1.5 gm depolymerized-polyester oligomer product was weighed into Erlenmeyer flask containing 25 ml pyridine. The sample was mixed at 110° C. to dissolve the reaction product. The solution was let to reflux for 30 min. Then the samples were titrated with 0.1 N potassium hydroxide solution in the presence of phenolphthalein indicator. The acid number was estimated as follows

$$Acid number = [ ( B - A ) \times N \times 56.1 ] / W$$

where:
A=KOH required for titration of the sample, mL,
B=KOH required for titration of the blank, mL,
N=normality of the KOH, and
W=sample used, g.

### Differential Scanning Calorimetry (DSC)

Differential scanning calorimetry (DSC) profiles of the samples were recorded on a DSC Q20 series TA Instruments under a N₂ atmosphere. Prior to use the interior chamber was brushed clean and heated to 100° C. for 5 minutes to remove residual/volatile compounds. Depolymerized-polyester oligomer product, renewable polyester, and renewable copolymer sample were each taken in separate aluminum pans for the measurement. The samples were subjected to 2 heating and cooling cycles in temperature range −60° C. to 265° C. at a heating/cooling rate of 10° C. min⁻¹.

### Gel-Permeation Chromatography

Gel-permeation chromatography was performed on depolymerized-polyester oligomer product, renewable polyester, and/or renewable copolymer using a Waters Breeze-2 system operated using Empower software. The system consisted of a model 1515 pump, model 2707 autosampler, and model 2414 refractive index detector. Elution was done with 1 ml/min flow of THF across three columns in sequence. The first column the samples passed through is a Phenomenex column Phenogel 5 μ 50 A 300×7.8 mm, the second is Phenomenex column 5 μ 10 E4A 300×7.8 mm, and the last one is Agilent Resipore 300×7.5 mm 3 μm column. These samples were tested against Agilent Technologies EasiCal PS2 polystyrene standards. These standards were prepared according to instructions using 0.2 μm filtered THF. The manufacturer provided molecular weight data for each standard and was input into the Empower software.

### Viscosity

Hot melt adhesives are typically used at temperatures between 120-180° C. and are mostly used at 177° C. Hence, viscosity was measured at 177° C. using a Brookfield viscometer according to ASTM3236 method.

### Mettler Softening Point

Mettler softening point was measured using Mettler dropping point apparatus according to ASTM D3954 method. This test is a measure of the softening point of the material. This method is used to measure the temperature at which the materials soften enough such that flow will occur.

### Peel Adhesion Failure Temperature (PAFT)

PAFT testing was performed using modified ASTM 4498 method. This testing is an adhesion test where the material is heated to 177° C. to become fully molten, then poured onto a piece of standardized kraft paper, then immediately bonded to another piece of kraft paper and allowed to make a bond. The bond is allowed to stand overnight at room temperature. The samples are then cut into 1″×1″ samples and hung in an oven with 100 g weights as loads in the peel mode of failure. The oven is heated at a rate of 30° C./hour and when the weight falls from the sample, the temperature is recorded. This test helps determine the relative sensitivity of a bond made with this material to exposure to higher temperatures. This is a key property for hot melt adhesives since many hot melts are used in a very wide variety of environmental conditions.

### Shear Adhesion Failure Temperature (SAFT)

SAFT testing was performed using ASTM 4498 method. This test is set up the same way the PAFT is set up, except that the weight is hung such that the failure is in the shear mode and the weight is 500 g. This test is another indication of how well a given adhesive will hold up when exposed to higher temperatures.

### Example 1: Effect of Catalyst Type on Depolymerization

Hydrolytic depolymerization of PET was carried out using various zinc salts in aqueous medium. The salts concentrations and the nature of the salts significantly influenced PET depolymerization. Under identical reaction conditions of 2 g clear PET flakes, 170° C. and 5 hours reaction time and 70% catalyst concentration (catalyst/PET ratio of 17) in a 500 ml autoclave, the reaction rate with respect to TPA production followed the order of ZnI₂>ZnBr₂>ZnCl₂, whereas MgBr₂ was ineffective. This shows that the anions of salts likely influence the depolymerization of PET. At the same zinc ion concentrations, the reaction rates (TPA formation per hour per gram of PET) approximately linearly increased with the size of anions of zinc salts as summarized below in Table 1.

TABLE 1
A comparison of PET depolymerization rates using different salts
as the reaction medium and different concentrations of
salts. Reaction conditions: 2 g clear PET flakes (washed and
mechanically flaked), 170° C. Reaction time is shown in the table.

| | | Reaction | TPA (g/g |
|---|---|---|---|
| Catalysts | Molar fraction | Time (h) | PET/hour) |
| ZnI₂ | 0.157 | 5 | 0.81 |
| ZnBr₂ | 0.09 | 5 | 0 |
| | 0.09 | 16.5 | 0.03 |
| | 0.152 | 5 | 0.41 |
| ZnCl₂ | 0.152 | 5 | 0 |
| MgBr₂ | 0.09 | 5 | 0 |
| | 0.09 | 16.5 | 0.03 |
| ZnBr₂-0.102/ | 0.05 + 0.107 | 5 | 0.03 |
| MgBr₂-0.05 | | | |

Additional experiments using mixture of ZnI₂ and ZnBr₂ at different ratios indicated that they are effective in the depolymerization of post-consumer PET feedstock even at lower temperature (140° C.). However, post-reaction solution became dark colored because of probably I2 formation and the solid product required an extensive washing with water to discolor.

### Example 2: Effect of PET Particle Sizes on Depolymerization

Without wishing to be bound by any particular theory, it is believed that the PET depolymerization would depend on the interactions between surface area of PET and the active sites of the reaction medium. Thus, it was hypothesized that the depolymerization rate could be influenced by the particle size of PET feed. In the first step, clear PET was cryogenically ground and filtered through different mesh size sieves. Fritsch company's Rotor Mill Pulverisett 14 (P14) classic line machine was used for the cryogenic grinding of PET. First, clear PET was cut into smaller pieces of around 2 cm×2 cm (FIG. 1A) and embrittled using liquid N₂. Embrittled pieces were fed into the mill. The milling was done using an 8 rib rotor at 20,000 RPM (revolutions per minute). PET pieces were completely ground, which were passed through sieves to obtain 1 mm size particles (FIG. 1B), 500 μm (FIG. 1C), and 200 μm μm (FIG. 1D). Quantitative recovery of particles was noted when the mill operated without using a high-performance cyclone separator. Slow heating of the rotor head was observed, but it did not cause PET ground to melt. Scanning Electron Microscopy (SEM) analysis revealed that the particle sizes of 500 μm and 200 μm batches varied in the range of 383-580 μm and 70-268 μm, respectively.

As used herein, the PET particle size of 1 mm refers to the ground PET obtained after passing through a sieve having sieve opening size of 1 mm (No. 18); PET particle size of about 500 μm refers to the ground PET obtained after passing through a sieve having opening size of about 500 μm; and PET particle size of about 200 μm refers to the ground PET obtained after passing through a sieve having opening size of 200 μm.

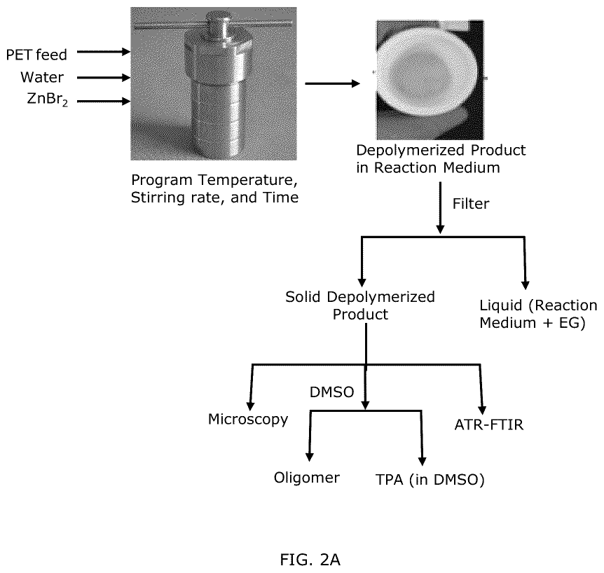

2 g clear ground PET particles (size of about 1 mm, about 500 μm, and about 200 μm) and flakes (size of about 2 cm×about 2 cm), were taken in a 500 ml autoclave containing 70% catalyst concentration (catalyst/PET ratio of 14) and depolymerization was carried out at 156° C. and 6 hours. Upon conducting each experiment for a set time, the reactor was cooled down to room temperature and opened. The product solution (FIG. 2A) was filtered. The solid depolymerized-polyester product (white color) was dried and weighed. Dried solid depolymerized-polyester product powder was analyzed by ATR-FTIR, SEM and dissolution method for quantification of terephthalic acid (TPA), oligomers and any unreacted PET. FTIR spectra gave characteristic vibrational stretching frequencies for different functional groups to distinguish unreacted PET, oligomers and TPA (FIGS. 2B-2D). SEM analysis of solid product was conducted to determine any changes in the particle size after depolymerization of PET feed. Smaller particles in solid product implied formation of TPA and/or oligomers (which is referred herein as depolymerized-polyester product) by depolymerization of PET feed. The amount of TPA in the resultant white solid powder was quantified by dissolution method. Because TPA is completely soluble in dimethyl sulfoxide (DMSO), known amount of solid product was added to a known amount of DMSO in a glass beaker and the mixer was stirred by hand. Dissolution of TPA in DMSO was observed. Any undissolved solid was filtered and dried and analyzed by ATR-FTIR. The vibrational signal of DMSO un-dissolved solid fraction matched with oligomer's (also referred to depolymerized-polyester oligomer product) vibrational pattern. When larger pieces of PET were used as a feed, any unreacted PET was separated from the solid product using a sieve.

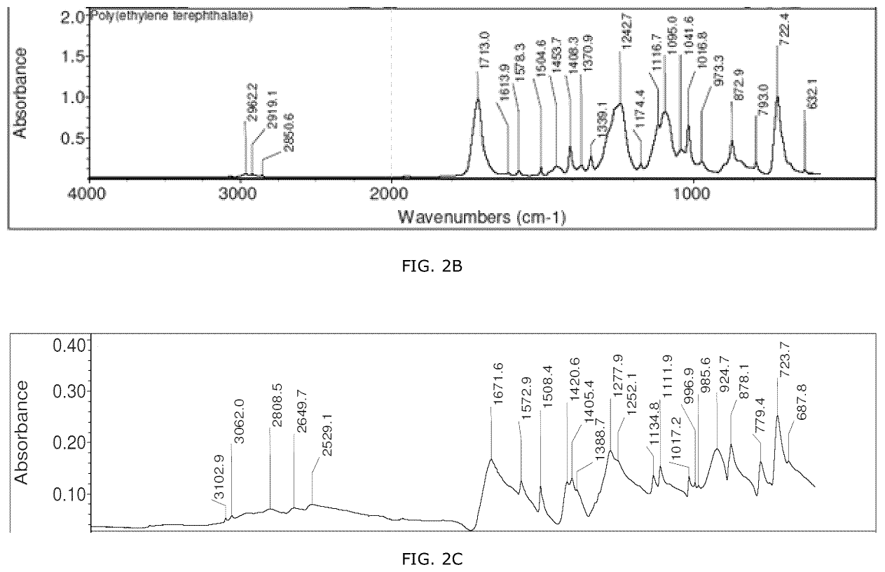

SEM images revealed that average particle size of the resultant white solid depolymerized-polyester product from PET depolymerization was much smaller than the particles size of PET feed. For example, particle sizes of 500 μm PET feed varied from 383 μm to 580 μm (FIG. 3A). After depolymerization of this PET feed for 6 hour at 156° C., the particle sizes of the resultant white solid were in the range of 14 μm-143 μm (FIG. 3B). Some larger particles in the SEM image are likely due to the aggregation of TPA because solid product was completely dissolved in DMSO. In some cases, larger particles in the solid product could be due to the presence of oligomers or unreacted PET. The liquid phase from the depolymerization reaction contains the reaction medium containing ZnBr₂ and EG, another monomeric product formed along with TPA.

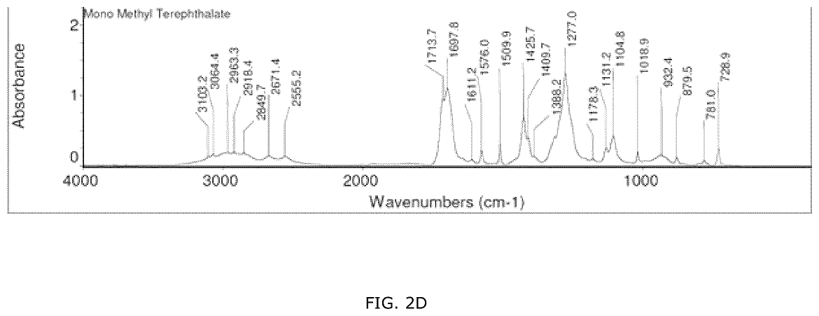

PET of 200 μm and 500 μm particles and PET flakes (FIGS. 4A-4B) in the range of 1 cm×1 cm to 2 cm×2 cm size) were used for depolymerization under comparable conditions to study the effect of particle size on the reaction. The results (FIG. 4C) that PET of three different sizes achieved comparable depolymerization performance. Quantitative depolymerization of all three batches of PET feed was observed with quantitative yield of TPA at 156° C. for 6 hour. The results indicated no significant influence of the particle size of PET feed on the degree of depolymerization as well as the yield of TPA for the reaction time of 6 hour.

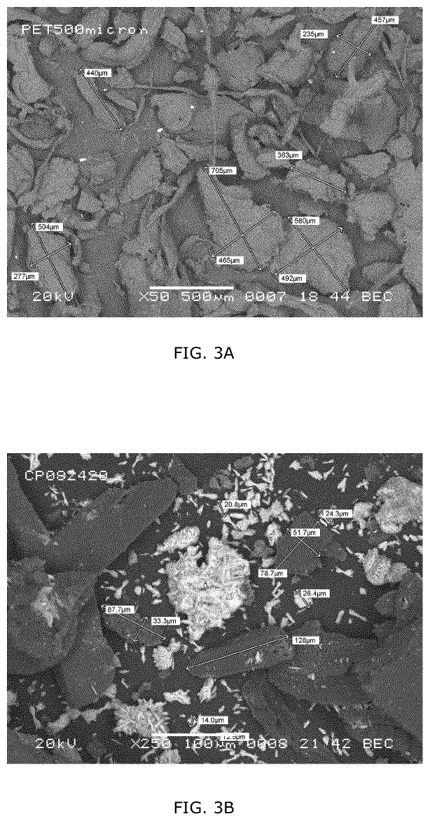

The texture of the resultant solid depolymerized-polyester product from PET depolymerization depends on the presence of TPA and/or oligomers. The solid depolymerized-polyester product is fine powder, like commercial petroleum-derived TPA (FIG. 5(a)), if TPA is the sole component in it. In case of depolymerized-polyester oligomer product as the major component in the product, the solid is crystalline (FIG. 5(b)). Thus, the present invention's depolymerization technology enables tuning the reaction conditions to produce either TPA or oligomers to meet diverse downstream application needs (FIG. 5).

### Example 3: Characterization of Ocean-Borne Mixed Plastics Contaminates and Composition

Ocean water contains various organic toxins, inorganic salts and other contaminates. The degree and the types of contaminates are expected to be different in ocean plastics collected from different locations in the ocean body or from different oceans. Various ocean-borne PET samples were collected—Pacific Ocean (Hawaii Kalimo beach), Indian Ocean (Maldives) and Atlantic Ocean (Dominican Republic). Post-consumer PET bottles from land waste was used as the control experiment (referred here to as ‘control’).

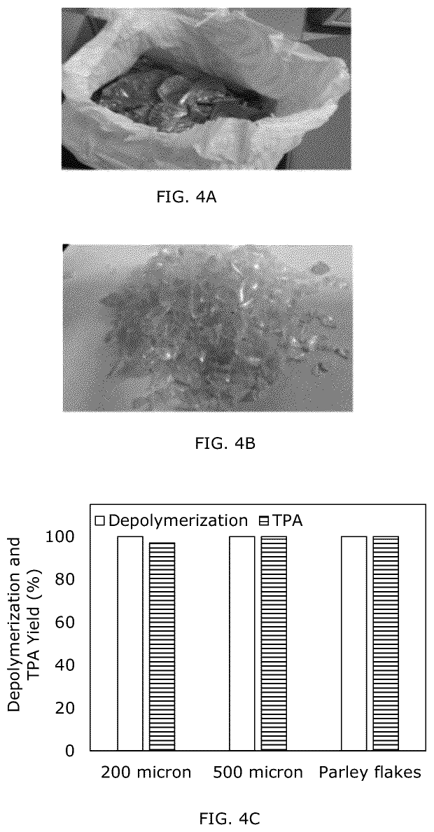

For determination of organic and inorganic contaminates in PET, as collected ocean and control PET samples were cut into small pieces (FIGS. 6A-6E). A known amount of each was added to a known amount of water or acetone in glass bottles. Each mixture was vortexed for a few hours to ensure organic, and inorganic contaminates in plastics can be washed into the liquid (water or acetone), then each mixture was filtered to obtain an aqueous wash and an organic wash from each PET sample. All aqueous solutions were analysed by Inductively Coupled Plasma Mas Spectroscopy (ICP-MS) and Liquid Chromatography Mass Spectroscopy (LC-MS) techniques for measuring inorganic metals and water soluble organic compounds, respectively. All organic solutions were analysed by Gas Chromatography Mass Spectroscopy (GC-MS) for measuring any organic compounds that are insoluble in water. The PET samples were also analysed by Energy Dispersive X-ray Spectroscopy (EDS) for measuring metal contents and comparing the results with ICP-MS data.

Metal contents in the five plastic samples were found to be Zn, K, Mg, Fe, Al, and/or Si. The five samples also contained small amounts (<1 ppm) of other metals such as Mn, Cu, Ni, Ba, Sr, Pb, Cr, V and Co. All un-processed ocean PET samples (Kalimo, Kalimo 914) showed the presence of significant amounts of Zn (2-12 ppm), K (2-16 ppm), and Si (12-33 ppm), in addition to Na. Kalimo 914 (sample collected from ocean water body) also had Al and Fe. Interestingly, ocean-borne PET flakes which were pre-processed and washed with hot water do not show the presence of Mg, Al, and Fe, and its Zn and Si amounts are less than that of Kalimo and Kalimo 914 samples. The results indicate that some inorganic contaminants (>50%) were washed off during hot wash when compared with the results of pre-processed ocean PET. It is also possible that PET samples collected from the Maldives (Indian Ocean) and Dominican Republic (Atlantic Ocean) contain fewer inorganic salts. The elemental profiles of HWF829 and control samples are similar. It is likely due to the fact that the HWF 829 sample was collected from Kalimo beach walkway where PET bottles were not exposed to ocean water, and hence the elemental profile of HWF 829 is very similar to the control sample.

Organic contaminates in the plastic samples are shown in Table 2. All ocean PETs (Kalimo, Kalimo 914) or PETs collected from close vicinity of the ocean body (HWF 829) contain 1,2-Bis(2-methoxyethoxy)ethane and Bisphenol A. Bisphenol A is absent in PET flakes which is likely washed out when this batch of ocean PET was hot washed. However, PET flakes, collected from the Indian Ocean and Atlantic Ocean, contain other organics such as polyaromatic (2-benzyl-2-dimethylamino-4′-morpholinobutryophenone, 4,4′-methylenediphenyldisocyanate) and phenolic (4-aminophenol), which are absent in PETs collected from Hawaiian ocean water (Pacific Ocean). It indicates that contaminates in ocean plastics largely depends on ocean water. Prior literature suggested that these organic compounds are present in ocean water. In contrast, the control sample showed none of these organic compounds, except a very small peak for melamine (not shown in Table 2), which likely comes from other plastics of the mixed plastics collected by the solid waste authority.

TABLE 2
Organic contaminates found in Ocean-borne PET

| | | Clear | | | |
|---|---|---|---|---|---|
| | | PET | | Kalimo- | HWF- |
| | Control | Flakes | Kalimo | 914 | 829 |
| Bisphenol A | — | — | ✓ | ✓ | ✓ |
| 1,2-Bis(2- | — | ✓ | ✓ | ✓ | ✓ |
| methoxyethoxy) | | | | | |
| ethane | | | | | |
| 2-Benzyl-2- | — | ✓ | — | — | — |
| dimethylamino- | | | | | |
| 4′-morpholinobutyro | | | | | |
| phenone | | | | | |
| 4-Aminophenol | — | ✓ | — | — | — |
| 4-4′- | — | ✓ | — | — | — |
| Methylenediphenyl | | | | | |
| diisocyanate | | | | | |

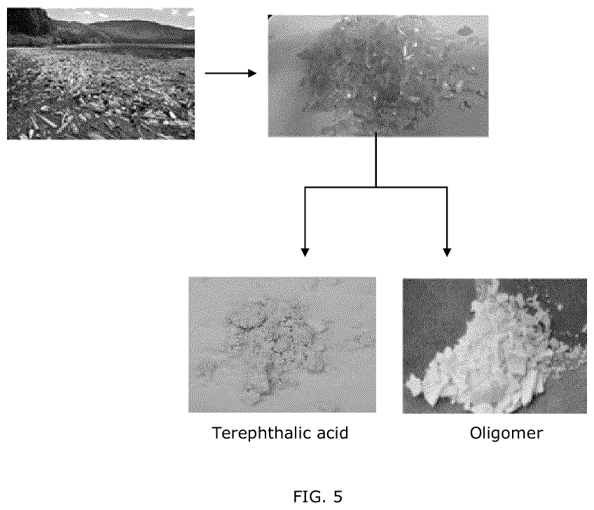

The effect of the organic contaminates found in the ocean-borne PET on the depolymerization of PET feed (500 μm) and PET flakes (1 cm×1 cm). Ocean water collected from the Pacific Ocean (Hawaii Kalimo beach) was used to prepare the reaction medium because it contained the maximum total amount (56 ppm) of inorganic metals. Controlled experiments were performed in parallel using the reaction medium prepared in DI water. The depolymerization yield in FIG. 7 shows that depolymerization of PET is more facile in terms of formation of higher amount of TPA, which is formed by additional depolymerization of oligomeric products, when the reaction was conducted using the reaction medium containing ocean water.

### Example 4: Optimization of Depolymerization Reaction Parameters in 500 Ml Autoclave

Reaction conditions were varied to optimize depolymerization of PET via C—O bond cleavage. Especially, experiments were conducted for understanding the best reaction temperature, reaction time, and ZnBr₂ concentration for optimal PET breakdown.

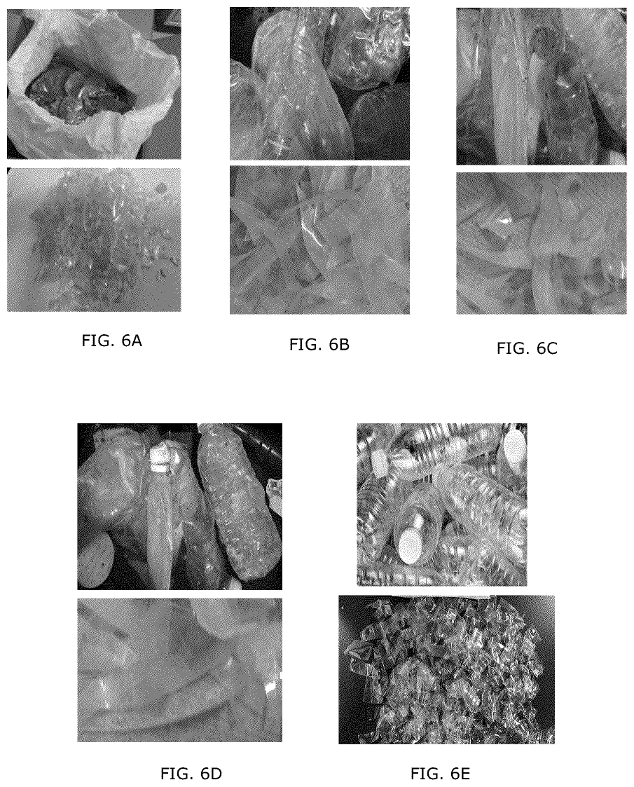

First, the reaction time was varied for depolymerization of clear PET flakes at 150° C. in 70% by weight of ZnBr₂, based on the total amount of reaction mixture. FIG. 8A shows PET depolymerization increases with an increase in the reaction time. The ratio of TPA to oligomer in the resultant solid depolymerized product also increased with the reaction time. The depolymerization is highly sensitive to ZnBr₂ concentration (FIG. 8B). Complete depolymerization of PET flakes with high ratio of TPA/oligomer was achieved at 70% ZnBr₂ concentration. When ZnBr₂ concentration increased above 75%, the product solution turned dark brownish and the resultant solid depolarized product was brownish, even after washing with DI water (not shown in FIG. 8B). Without wishing to be bound by any particular theory, it is hypothesized that Zn²⁺ likely forms a colored complex with the process generated EG or TPA at higher concentration of ZnBr₂ in the reaction medium. FIG. 8C shows that PET depolymerization and the yields of TPA and oligomer and their ratios significantly depend on the reaction temperature. The depolymerization productivity increased with temperature. At temperatures >170° C., the solutions become dark brownish, similar to what was observed at higher ZnBr₂ concentration, and the intensity of the coloration was darker at 180° C. than that of 170° C.

### Example 5: Depolymerization of Colored PET

Commercial PETs include clear PET, colored PET, modified PET-G, degenerated PET, PET films, PET fibers and other forms. Currently, clear PET is mechanically recycled while such recycling of colored PET, PETG, films and other forms polyesters are difficult because of their higher mechanical strength and presence of different types of additives. Depolymerization of colored PET by other chemical recycling technologies such as glycolysis and methanolysis are also difficult, thus clear PET is used as a sole feedstock in such depolymerization processes. Herein the feasibility of depolymerization of colored PET by the inventive process disclosed herein was evaluated.

2 g of colored PET sample was magnetically stirred in with 40 g of 70% by weight of aqueous ZnBr₂ solution and the depolymerization was carried at 150° C., for 6 hours. After cooling down the reactor, the reaction mixture was filtered to recover the catalyst solution using a 45 μm filter. The solid residue was further washed with water to remove the residual catalyst. The solid depolymerized-polyester product sample was then dried in an oven at 65° C. overnight. The dried solid depolymerized- polyester product sample was crushed with mortar and pestle to break the loose aggregates. The sample was screened using 700 μm and 105 μm sieves to obtain white depolymerized-polyester oligomer product powder sample of particle size <700 μm and <105 μm. Depolymerization yield of ˜100% was achieved based on the <700 μm particle size depolymerized-polyester oligomer product. The reaction conditions used herein produced depolymerized-polyester oligomer product as the major product, which is beneficial for the synthesis of polymers.

### Example 6: Scalability of Depolymerization Process

PET depolymerization process for producing the depolymerized-polyester product (depolymerized-PET oligomer product) was scaled up in a 5 L autoclave equipped with impeller and electrical heating system. Depolymerization of PET was scaled up by ˜250 times in terms of PET quantity compared to prior experiments in 500 ml reactor. The 5 L autoclave had better mixing and temperature control compared to 500 ml autoclave with magnetic stirrer mixing and oil bath heating system. Therefore, lower catalyst concentrations and temperature were used during depolymerization. The process was carried out at temperature of 160° C., 50% ZnBr₂ and ZnBr₂/PET ratio of 10 and 21, PET quantities of ˜100 g and ˜500 g. Different types of post-consumer PET feedstock such as clear PET flakes, machine cut color and clear PET mixture were also evaluated. The scale up reaction was set up for a bit longer time to achieve 100% depolymerization (Table 3), but it could be possible that the reaction was completed sooner than the set time. % Degree of depolymerization (% DP) was calculated based on the depolymerized PET of size <700 μm. The results summarized in Table 3 indicates that 100% degree of depolymerization can be achieved for clear PET quantities up to 500 g at lower ZnBr₂/PET ratio that was used in small scale reactions. The results of Table 2 also indicate that clear PET flakes and mixed color and clear PET achieved comparable depolymerization productivity in the present inventive process disclosed hereinabove.

TABLE 3
PET depolymerization at 160° C, 50% ZnBr₂
solution at varying ZnBr₂/PET ratio and time.

| | | | ZnBr₂ | Degree of | |
|---|---|---|---|---|---|
| | | | conc | depoly- | |
| | ZnBr₂/ | | in water | merization | Reaction |
| | PET | PET | (% by | % DP | time |
| PET Feedstock | ratio | (g) | weight) | (700 μm) | (hr) |
| Mixed PET | 21 | 95 | 50% | 50 | 7 |
| Mixed PET | 10 | 434 | 50% | 100 | 10 |
| Clear PET flakes | 21 | 95 | 50% | 96 | 7 |
| Clear PET flakes | 10 | 500 | 50% | 100 | 10 |
| Color & clear PET | 21 | 95 | 50% | 94.9 | 7 |
| Color & clear PET | 10 | 450 | 50% | 98.7 | 10 |

### Example 7: Depolymerization of Different PET Feedstocks in 5 L Reactor

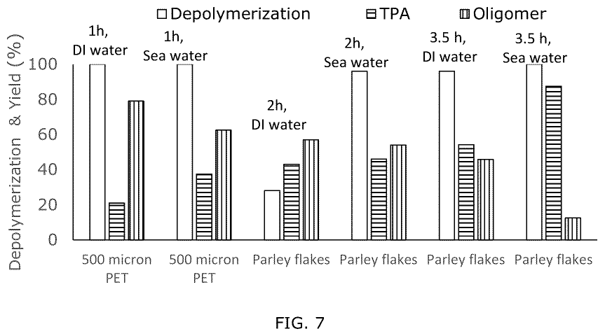

The depolymerization process according to the present invention, as disclosed hereinabove, was tested for various PET samples (FIG. 9). These samples included colored-clear PET (unwashed with aluminum impurities intact), PET film, clear PET (hot washed and caps/label removed), mixed PET (unwashed and caps/labels intact), and ocean-borne PET from Hawaii beach (HWF).

Ocean-borne PET bottles from Hawaii beach were scissor cut into 2 cm×2 cm pieces without pre-washing in our lab. Color-clear PET and mixed PET were machine cut flakes without any prior washing or separations of PET bottle's labels and caps. Mixed PET has other polymeric impurities. PET thin films samples were used in the form of PET flakes (thickness about 20 to 30 μm with average dimensions of 2 cm×2 cm).

Depolymerization of PET sample was carried out by mixing about 500 g of post-consumer PET feedstock with 5000 gm of 50% aqueous ZnBr₂ solution at 160° C., 1300 RPM for 10 hours in 5 L autoclave. After cooling down the reactor, the reaction mixture was filtered to recover the catalyst solution using a 45 μm filter. The solid residue was further washed with water to remove the residual catalyst. The solid depolymerized-polyester product sample was then dried in an oven at 65° C. overnight. The dried depolymerized-polyester product sample was crushed with mortar and pestle to break the loose aggregates. The product was first screened using a 700 μm sieves to obtain white depolymerized-polyester oligomer product of particle size ≤700 μm. The screened product was further screened using a 105 μm sieves to obtained product of ≤105 μm size. Depolymerization yield of ˜100% was achieved based on the product's particle size of ≤700 μm.

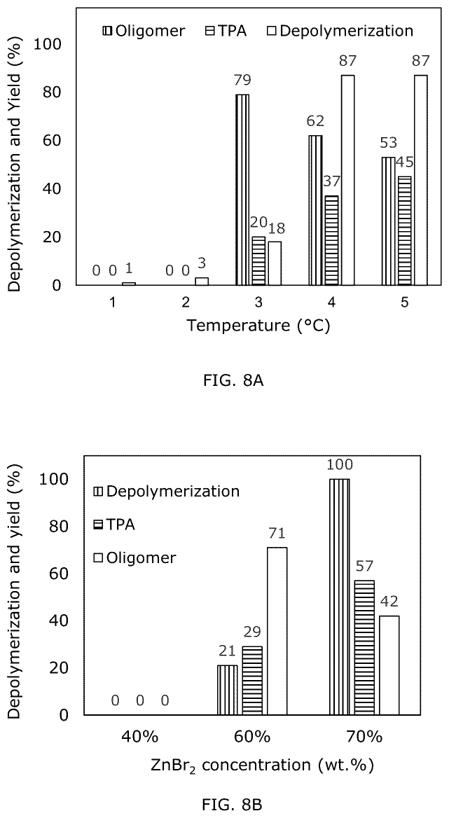

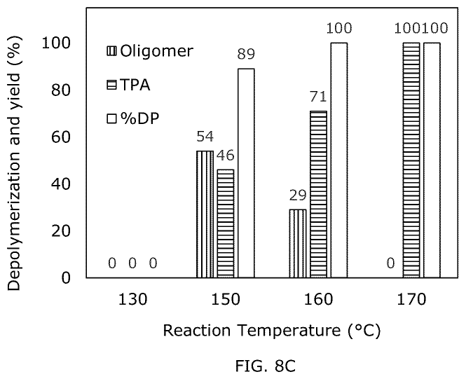

The depolymerization results in FIG. 10 indicated that color-clear PET (unwashed with aluminum impurities intact), PET film, clear PET (hot washed and caps/label removed), mixed PET (unwashed and caps/labels intact), and ocean-borne PET were effective to produce white depolymerized-polyester oligomer product. No significant difference in the depolymerization of color, clear PET was noted when compared with clear PET flakes. Mixed PET showed lower degree of depolymerization which is due to the presence of other polymers in this feedstock which did not depolymerize in our process. This indicates that our process is selective for breaking down only PET. In case of PET film lower catalyst concentration could completely depolymerize sample at same temperature and time as that of other PET feedstocks. This was due to the higher surface area provided by the thin and long PET flakes compared to thick and short flakes used in other PET feedstocks. Depolymerized powder from PET film turned dark brownish (FIG. 11) even after prewashed with hot water which suggest that discoloration may have resulted from the additives present in this feedstock.

### Example 8: Characterization of Depolymerized-Polyester Oligomer Product

The depolymerized-polyester product of PET depolymerization can be used as a potential feedstock for synthesizing renewable PET and other polymers such as epoxies, polyurethanes, unsaturated polyesters etc. Therefore, depolymerized-PET oligomer product (Olig1000-700: oligomer having average molecular weight 1000 and size of less than or equal to 700 μm.) obtained from clear PET was characterized for its functionality, molecular weight, and thermal properties which are useful in strategizing the reaction chemistries for synthesis of new polymers.

| | Mₙ | M_{w} | |
|---|---|---|---|
| Polymer | (from GPC) | (from GPC) | PDI |
| Olig 1000-700 | 926 | 1045 | 1.12 |

The results of the Titrimetric analysis showed the hydroxyl number and acid number of the depolymerized-polyester oligomer product are 40 mg KOH/g and 220 mg KOH/g, respectively.

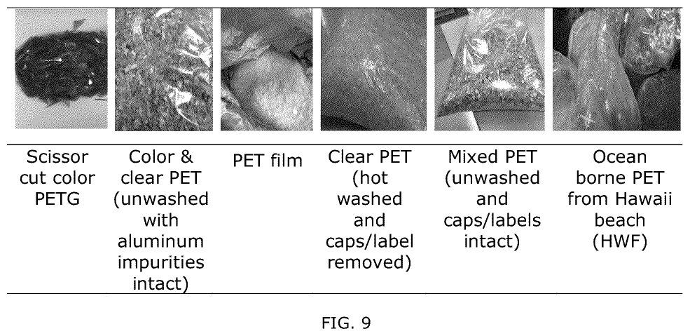

FIG. 12 shows the molecular weight distribution of the depolymerized-polyester product in a GPC plot. It was observed that the depolymerized-polyester oligomers sample contained oligomer fractions with molecular weight ranging from 200 to 2000 Da.

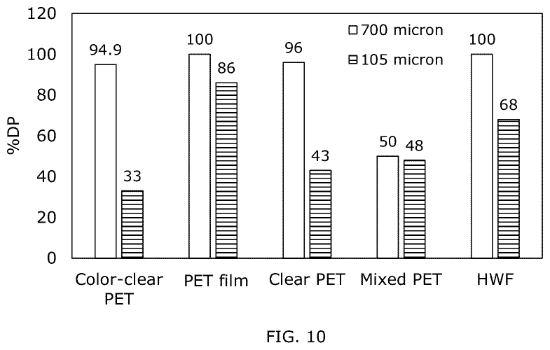

The second heating traces of the samples are reported herein and used for the determination of glass transition temperature (T_{g}) of the samples. FIG. 13 shows the DSC thermogram of Depolymerized-polyester oligomers samples. The sample exhibited glass transition (T_{g}) and melting temperature of 35° C. and 131° C., respectively.

### Example 9: Effect of Reaction Conditions on PET Depolymerization for Scale Up Reactions

### Effect of Temperature

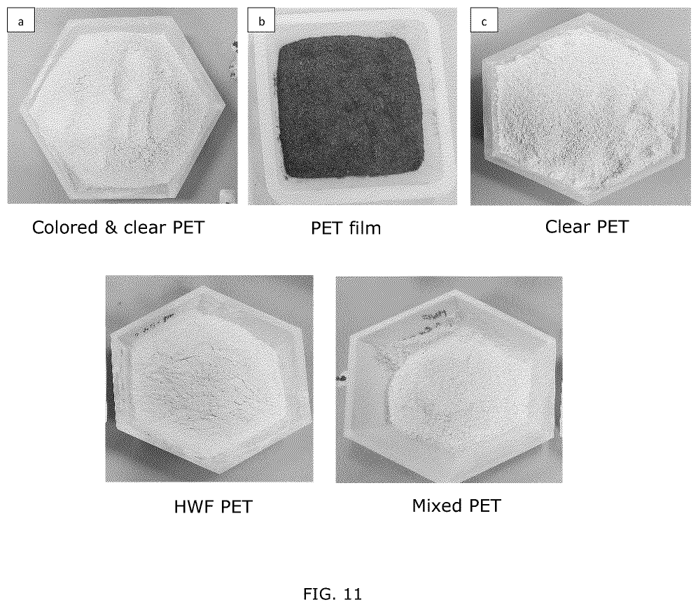

The effect of temperature on the degree of depolymerization of clear PET was studied at three different temperatures (150° C., 155° C. and 160° C.) as shown FIG. 14. Depolymerization and depolarization product screening was carried out using the same method as described in Example No. 7. Percentage of depolymerization (% DP) was calculated as percentage fraction of depolymerized powder of a particular size (≤700 μm with reference to the amount of PET that was used for the depolymerization.

When the reaction temperature was reduced from 160° C. to 155° C., the PET sample did not completely depolymerize, the % DP reduced to 84.2%. At 150° C. % DP was further reduced to 73.3% with lowest water soluble and DMSO soluble fractions suggesting depolymerized-polyester product to be mostly oligomeric mixture.

### Effect of Catalyst Concentration

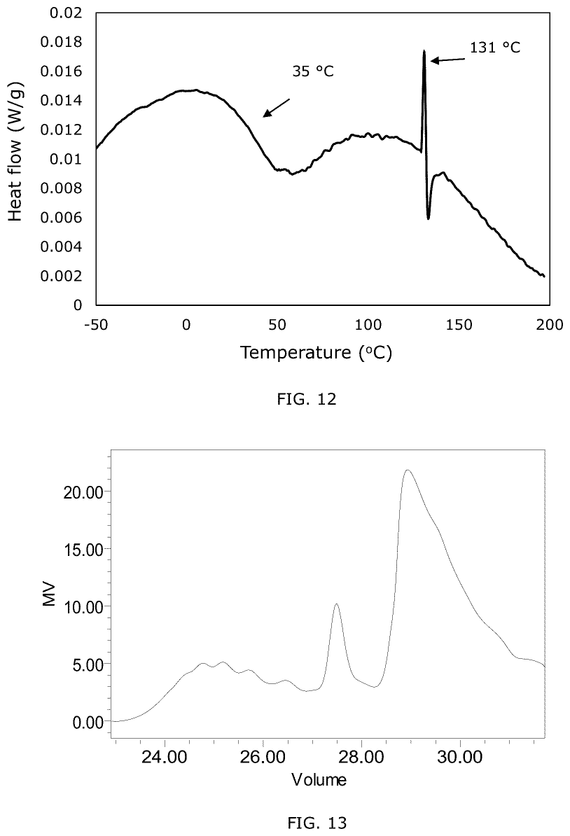

Depolymerization of clear PET was carried out at various ZnBr₂ concentrations (50%, 60% and 70% ZnBr₂). Depolymerization and powder screening was carried out using the same method as described in Example No. 7. The results as shown in FIG. 15A shows that the % DP decreased with decreasing ZnBr₂ concentrations in the reaction. The percentage of water-soluble (mass loss due to the solubility of depolymerized-polyester product and/or EG formation) and DMSO soluble fractions (mostly TPA monomer) also decreased with decreasing ZnBr₂ concentration (FIG. 15B).

### Effect of Time

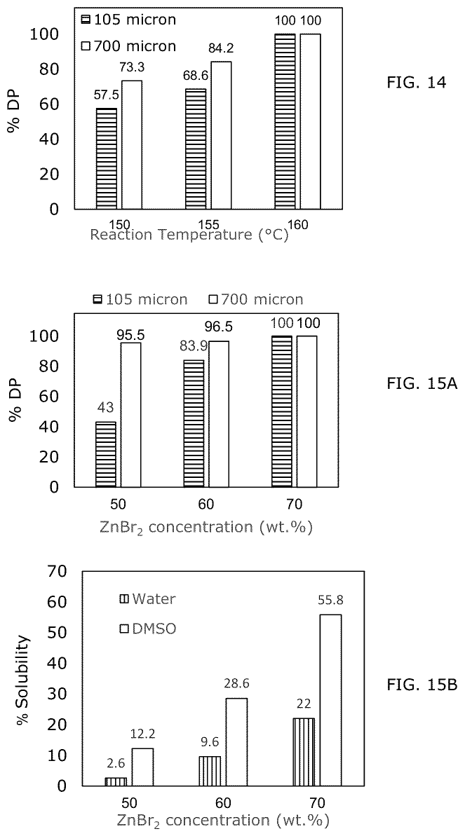

Depolymerization of clear PET was carried out at various depolymerization times (5 hours and 7 hours). FIG. 16A shows that the 5 hours experiment resulted in lower % DP (83%) as compared to complete (100%) % DP for 7 hours. The water and DMSO soluble fractions were also lower for the reaction conducted for shorter time (FIG. 16B).

### Example 10: Recyclability of Catalyst Solution

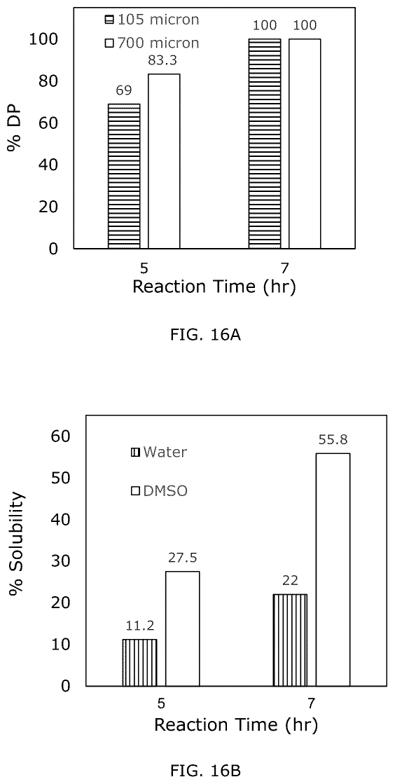

The recyclability of aqueous ZnBr₂ solution was tested for up to 5 cycles. In each cycle about 500 g of PET feedstock was depolymerized. After the reaction, solid white product was separated by vacuum filtration and the liquid phase re-used in the next cycle. FIG. 17A shows that % depolymerization of PET feedstock (clear PET flakes) in all cycles is similar. The recovered ZnBr₂ solution after each cycle was analysed for measuring the amount of EG formation by using Anton Paar's DSA 5000M instrument which employed density and sound velocity measurement techniques. FIG. 17B shows ethylene glycol concentration in the recovered 50% ZnBr₂ solutions. It should be noted from FIG. 17B that EG formation was very low and varied between 2.5 wt. % (after the 1st recycle/run) to 2.9 wt. % (after the third recycle/run). Due to the core shell mechanism of depolymerization of PET feedstock, small quantity of EG formation is inevitable in the process. This results further evidenced that oligomers are the major fraction in the Depolymerized-polyester oligomer product. The recovered ZnBr₂ solutions each cycle appeared colorless. However, after few days a small amount brown color precipitation was observed in the solution. This could be due to the complexation between water soluble small amount of EG and ZnBr₂.

### Examples Related to Polymerization of Depolymerized-Polyester Oligomer Products to Upcycled PET

### Example 11: Development of Reaction Conditions for Polymerization Using Standard TPA

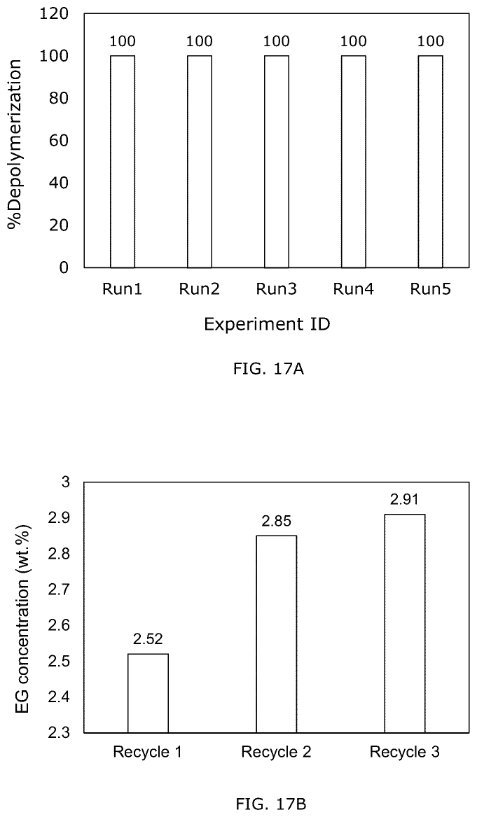

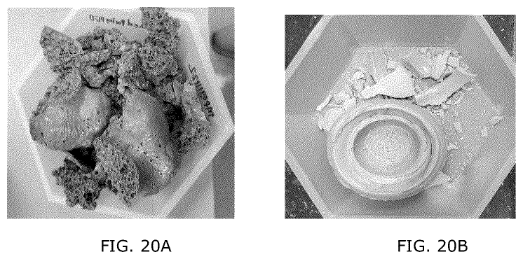

Acid number analysis in Example 8 showed that the depolymerized-PET oligomer product may have small quantities of TPA and oligomers with carboxyl end groups. Therefore, the esterification reaction between the TPA and EG was studied at various temperatures. Acid numbers of the synthesized esters was monitored using titrimetric analysis. Since the solubility of TPA in EG is very poor, higher temperatures were required for esterification of TPA's carboxylic groups. Significant reduction in acid number was observed when esterification was done in the temperature range of 240° C. to 310° C. (FIG. 18). FIG. 18 shows acid numbers of esterified TPA decreased as the esterification temperature increased. The esterified TPA at 310 C was then subjected to polycondensation 290° C. FIGS. 20A and 20B shows texture of as-synthesized PET (FIG. 20A: R10; FIG. 20B: R9). IV and T_{g} of this PET were 0.18 dL/g and 65° C., respectively, which are lower than control PET.

### Example 12: PET Synthesis From Depolymerized-Polyester Oligomers Derived From Various PET Feedstocks

Depolymerized PET powder (depolymerized-PET oligomer product) was obtained from various PET feedstocks as disclosed above in Examples Nos. 7 and 10. PET synthesis was carried out in a 250 ml polymerization reactor equipped with a condenser, vacuum pump and inlet for nitrogen. 80 gm of depolymerized-PET oligomer product was mixed with a 120 gm EG containing 320 mg Sb₂O₃ at 800 RPM. The mixture was purged under nitrogen at room temperature (25° C.) for 15 minutes. The mixture was then heated to carry out esterification at the temperatures in the range 300° C. to 310° C. under nitrogen atmosphere for 2 to 4.5 hours. After esterification step nitrogen outlet was opened for venting water vapor and unreacted EG vapor for 30 minutes. Then vacuum pulling was started to remove the unreacted EG and EG generated during the subsequent polycondensation step. The polycondensation was carried out for 6 hours to 10.5 hours between the temperature range of 270° C. to 300° C. under vacuum. The polymer sample was characterized for its properties without any purification. Table 4 summarizes the reaction conditions (temperature and time of esterification and polycondensation reactions) and IV (intrinsic viscosity) and T_{g} of the as-synthesized renewable PET from various feedstocks. The results show that renewable PET exhibited higher IV and T_{g} than the depolymerized-PET oligomer which was used as a feedstock in the polymerization.

TABLE 4
PET synthesis runs from depolymerized
PET derived from different feedstocks.

| | | Clear | Mixed | Colored- |
|---|---|---|---|---|
| PET source | | PET | PET | clear PET |
| Depolymerized-PET | | 60 | 80 | 80 |
| oligomer product (g) | | | | |
| EG (g) | | 50 | 120 | 120 |
| Sb₂O₃ catalyst (mg) | | 60 | 120 | 320 |
| Esterification | Temp (° C.) | 260 | 310 | 300 |
| Reaction | Time (hrs) | 2 | 4.5 | 4.5 |
| Polycondensation | Temp (° C.) | 270 | 300 | 300 |
| Reaction | Time (hrs) | 6 | 10.5 | 9.5 |
| As-synthesized | IV (dL/g) | 0.15 | 0.33 | 0.41 |
| Renewable PET | T_{g} (° C.) | 58 | 70 | 78.5 |

Example Nos. 13 to 17 disclosed hereinbelow show the effect of reaction conditions such as temperature, catalyst concentration, additives, and metal salt addition on the properties of the as-synthesized Renewable PET. Additional polymerization reactions were carried out using the procedure described in Example 12, but at varying reaction conditions as described.

### Example 13: Effect of Esterification Temperature on Properties of PET

Example No. 11 showed that the temperature has a significant influence on the esterification of carboxyl groups. Hence, PET was synthesized using depolymerized-PET oligomer powder at various esterification temperatures to see the effect on the properties of the as-synthesized renewal PET. It was observed that at constant polycondensation temperature (Tpc) of 270° C., increasing esterification temperature (Te) from 200° C. to 260° C. improved the degree of polymerization. As observed from the experimental runs R3 to R9 in Table 5, IV of polymer samples was increased from 0.12 to 0.27 dL/g with an increase in Te, indicative of higher molecular weight of PET. IV data for depolymerized sample could not be obtained as it was not completely soluble in phenol/tetrachloroethane mixture. The T_{g} of these polymer samples (R3 to R9 of Table 5) was in the range of 55° C. to 65° C., which was higher than the depolymerized-PET oligomer product's T_{g} of around 35° C.

### Example 14—Effect of Polycondensation Temperature on the Properties of PET

PET synthesis runs (R9 and R10 of Table 5) were performed at different polycondensation temperatures at constant esterification temperature of 260° C. IV of PET sample increased from 0.27 to 0.4 by increasing the polycondensation temperature from 270° C. to 290° C. It was observed that higher polycondensation temperature have a significant impact on the degree of polymerization.

Overall, the polymerization runs showed that higher temperatures (>270° C.) are necessary for both esterification and polycondensation of the Depolymerized-PET oligomers to achieve significant improvement in IV.

### Example 15: Effect of Catalyst Concentration on the Properties of PET

PET synthesis runs (R13 and R12 of Table 5) were carried out by increasing the catalyst concentration from 1.5 mg/g of depolymerized-PET oligomers to 4 mg/g depolymerized-PET oligomers at similar reaction conditions. At higher catalyst concentration, IV and T_{g} values of the as-synthesized renewal PET samples increased to 0.41 dL/g and 78° C. from 0.33 dL/g and 70° C., respectively. However, the color of the renewable PET became more dark brown at higher catalyst concentration.

TABLE 5
Reaction conditions to produce renewable PET using
depolymerized-PET oligomer product as a feedstock.

| | Post-consumer | Reactants (g) | | | | |
|---|---|---|---|---|---|---|
| | PET feedstock | Depolymerized- | | | | |
| | used to produce | PET oligomer | | | Properties | |
| Sample | Depolymerized- | product or | | | IV | Tg |
| ID | PET oligomers | standard TPA | EG | Reaction conditions | (dL/g) | (° C.) |
| R1 | TPA | 50 | 78 | Sb₂O₃- 100 mg, Te-295, | 0.17 | 52 |
| | | | | te- 5, Tpc- 290, tpc-3 | | |
| R2 | TPA | 60 | 60 | Sb₂O₃- 120 mg, Te-300, | 0.19 | 58.4 |
| | | | | te- 6, Tpc- 300, tpc-6 | | |
| R3 | Clear PET flake | 45 | 50 | Sb₂O₃ - 60 mg, Te-200, | 0.18 | 69 |
| | | | | te- 2, Tpc- 270, tpc-5 | | |
| R4 | Clear PET flake | 30 g | 50 | Sb₂O₃ - 30 mg, Te-200, | 0.24 | 58.5 |
| | | Depolymerized- | | te- 2, Tpc- 285, tpc-3 | | |
| | | PET oligomer | | | | |
| | | product and 15 g | | | | |
| | | TPA | | | | |
| R5 | Clear PET flake | 60 | 70 | Sb₂O₃ - 120 mg, Te- | — | 65 |
| | | | | 240, te- 4, Tpc- 270, | | |
| | | | | tpc-6 | | |
| R6 | Clear PET flake | 60 | 50 | Sb₂O₃- 60 mg, Te-260, | 0.15 | 58 |
| | | | | te- 2, Tpc- 270, tpc-4 | | |
| R7 | Clear PET flake | 60 | 50 | Sb₂O₃- 60 mg, Te-260, | 0.12 | 55 |
| | | | | te- 3, Tpc- 270, tpc-5 | | |
| R8 | Clear PET flake | 70 | 45 | Sb₂O₃- 70 mg, Titanium | 0.18 | 68 |
| | | | | butoxide-70 mg Te-260, | | |
| | | | | te- 7.5, Tpc- 270, tpc-6, | | |
| | | | | Additives added | | |
| R9 | Clear PET flake | 70 | 40 | Sb₂O₃- 70 mg, Titanium | 0.27 | — |
| | | | | butoxide-70 mg Te-260, | | |
| | | | | te- 4, Tpc- 270, tpc-6, | | |
| | | | | Additives added | | |
| R10 | Mixed PET flakes | 70 | 35 | Sb₂O₃- 70 mg, Titanium | 0.4 | 69 |
| | | | | butoxide-70 mg Te-260, | | |
| | | | | te- 5, Tpc- 290, tpc-5 | | |
| R11 | Clear PET flake | 80 | 60 | Sb₂O₃- 80 mg, Titanium | 0.42 | 72 |
| | | | | butoxide-80 mg Te-290, | | |
| | | | | te- 6, Tpc- 290, tpc-6, | | |
| | | | | Additives added | | |
| R12 | Color & clear PET | 80 | 120 | Sb₂O₃- 320 mg, Te-300, | 0.41 | 78 |
| | | | | te- 4.5, Tpc- 300, tpc- | | |
| | | | | 9.5 | | |
| R13 | Mixed PET flakes | 80 | 120 | Sb₂O₃- 120 mg, Te-310, | 0.33 | 70 |
| | | | | te- 4.5, Tpc- 300, tpc- | | |
| | | | | 10.5 | | |
| R14 | TPA | 80 | 65 | Sb₂O₃- 80 mg, Titanium | 0.32 | — |
| | | | | butoxide-80 mg Te-290, | | |
| | | | | te- 6, Tpc- 290, tpc-10, | | |
| | | | | Additives added | | |

Te = esterification temperature in ° C., te = esterification time in hours, Tpc = polycondensation temperature in ° C., Tpc = polycondensation time in hours.
IV = Intrinsic viscosity.
T_{g} = glass transition temperature.
Sb₂O₃ was used as a catalyst.
In a few experiments, additives (phosphoric acid (60 mg) and triphenyl phosphite (60 mg)) were used.

### Example 16: Effect of Additives on PET Color

PET synthesis run R9 (Table 5) was carried out with the addition of thermal stabilizing additives (phosphoric acid and triphenyl phosphite). Addition of thermal stabilizing additives reduced the PET discoloration compared to PET synthesized without addition of additives (R10 of Table 5) at similar reaction conditions (FIGS. 2aA and 20B). This may be due to the reduction in thermal degradation of polymer chains at high reaction temperature in presence of additives.

### Examples Related to Co-Polymerization of Depolymerized-Polyester Oligomer Products to Adhesives

### Example 17: Polycaprolactone Synthesis From Commercial Caprolactone

Polycaprolactone was synthesized by ring-opening polymerization of caprolactone monomer in the presence of Sb₂O₃ and tin (II) octoate initiators. 225 g of caprolactone was taken in the 250 ml polymerization reactor. Then 270 mg of Sb₂O₃ and 1600 mg of tin (II) octoate were added to the reactor. The mixture was purged with N₂ for 15 min before heating the mixture to 285° C. under N₂. Reaction was continued for 8 hours at this temperature. A white colored polycaprolactone was obtained.

### Example 18: Co-Polymerization of Depolymerized-PET Oligomers and Caprolactone at 40:60 (W/W) Ratio

A 40 g of depolymerized-PET oligomer sample produced from clear PET flakes (hot washed and caps/label removed) with particle size of ≤700 μm from Example No. 7 was mixed with a mixture that contained 60 gm caprolactone, 120 mg Sb₂O₃ and 800 mg Tin (II) octoate. The mixture was stirred at 800 RPM for 2 hours at room temperature (25° C.) to form a homogenous mixture in a 250 ml polymerization reactor equipped with a condenser, vacuum pump and inlet for nitrogen. The mixture was purged with nitrogen for 15 minutes before ramping the temperature to 285° C. Then, nitrogen outlet was closed and the reaction mixture was maintained under nitrogen atmosphere at 285° C. for 4 hours. After 4 hours vacuum pulling was started to remove any EG vapor that could have been formed during polycondensation. After 10 hours of reaction, a brown colored viscous and gluey adhesive renewable copolymer (CP40) was formed which solidified after few days. The copolymer showed hot melt adhesive characteristics. The copolymer sample was characterized for its intrinsic viscosity, molecular weight, glass transition temperature without any purification. The results are summarized in Table 6.

### Example 19: Co-Polymerization of Depolymerized-Polyester Oligomers and Caprolactone at 60:40 (W/W) Ratio

A 60 g of depolymerized-PET oligomer sample produced from clear PET flakes (hot washed and caps/label removed) with particle size of ≤700 μm from Example No. 7 was mixed with a mixture containing 40 gm caprolactone, 20 gm EG, 120 mg Sb₂O₃ and 800 mg tin (II) octoate. The mixture was stirred at 800 RPM for 2 hours at room temperature to form a homogenous mixture in a 250 ml polymerization reactor equipped with a condenser, vacuum pump and inlet for nitrogen. The mixture was purged with nitrogen for 15 minutes before ramping the temperature to 285° C. Then nitrogen outlet was closed and the reaction mixture was maintained under nitrogen atmosphere at 285° C. for 4 hours. After 4 hours vacuum pulling was started to remove the unreacted EG and EG vapor formed during polycondensation. After 10 hours of reaction, a brown colored viscous and gluey adhesive renewable copolymer (CP60-1) was formed, which solidified after few days. The copolymer showed hot melt adhesive like characteristics. The polymer sample was characterized for its intrinsic viscosity, molecular weight, glass transition temperature without any purification (Table 6).

### Example 20: Co-Polymerization of Depolymerized-PET Oligomers and Polycaprolactone

Pre-synthesized polycaprolactone from Example No. 17 was used for copolymerization with the Depolymerized-PET oligomers product. A 60 g of depolymerized-PET oligomer sample derived from clear PET flakes (hot washed and caps/label removed) with particle size of ≤700 μm from Example No. 7 was mixed with a mixture containing 40 g polycaprolactone, 60 g EG, 800 mg Sb₂O₃ and 100 mg tin (II) octoate. The mixture was stirred at 800 RPM for 2 hours at room temperature to form a homogenous mixture in a 250 ml polymerization reactor equipped with a condenser, vacuum pump and inlet for nitrogen. The mixture was purged with nitrogen for 15 minutes before ramping the temperature to 285° C. Then nitrogen outlet was closed and the reaction mixture was maintained under nitrogen atmosphere at 285° C. for 4 hours. After 4 hours vacuum pulling was started to remove the unreacted EG and EG vapor formed during polycondensation. After 10 hours of reaction a light brown colored, semi-transparent and viscous and gluey adhesive renewable copolymer (CP60-2) was formed. The polymer sample was characterized for its intrinsic viscosity, molecular weight, glass transition temperature without any purification (Table 6).

### Example 21: Co-Polymerization of PET Flakes and Polycaprolactone

A 60 g of clear PET flakes sample was mixed with a mixture containing 40 g of polycaprolactone (pre-synthesized as per procedure mentioned in Example No. 17) and 30 gm EG. The mixture was melted at 285° C. under N₂ inert atmosphere under mixing. A 120 mg Sb₂O₃, 800 mg tin (II) octoate and 100 mg of triphenyl phosphite mixture in 10 gm EG was added to the reactor. The mixture was stirred under N₂ at 700 RPM for 4 hours at 285° C. in a 250 ml polymerization reactor equipped with a condenser, vacuum pump. After 4 hours, N₂ inlet was turned off and the vacuum pulling was started to remove unreacted EG and EG vapor formed during polycondensation. After 10 hours of reaction an off-white colored, gluey adhesive copolymer (CP60-3) was formed. The copolymer showed soft, pressure sensitive adhesive like characteristics. The polymer sample was characterized for its intrinsic viscosity, molecular weight, glass transition temperature without any purification (Table 6).

### Example 22: Co-Polymerization of Depolymerized-Polyester Oligomers and Caprolactone at 80:20 (W/W) Ratio

80 g of depolymerized-PET oligomer sample produced from clear PET flakes (hot washed and caps/label removed) with particle size of ≤700 μm from Example No. 7 was mixed with a mixture containing 20 gm EG, 20 gm caprolactone, 120 mg Sb₂O₃ and 800 mg tin (II) octoate. The mixture was stirred at 800 RPM for 2 hours at room temperature to form a homogenous mixture in a 250 ml polymerization reactor equipped with a condenser, vacuum pump and inlet for nitrogen. The mixture was purged with nitrogen for 15 minutes before ramping the temperature to 285° C. Then, nitrogen outlet was closed and the reaction mixture was maintained under nitrogen atmosphere at 285° C. for 3 hours. After 3 hours vacuum pulling was started to remove unreacted EG and EG vapor formed during polycondensation. After 9 hours of reaction, a brown colored viscous and gluey adhesive renewable copolymer (CP80) was formed, which solidified upon cooling to room temperature. The copolymer showed hot melt adhesive like characteristics. The polymer sample was characterized for its intrinsic viscosity, molecular weight, glass transition temperature without any purification (Table 6).

### Example 23: Co-Polymerization of Depolymerized-Polyester Oligomers and Caprolactone at 95:5 (W/W) Ratio

A 95 g of Depolymerized-PET oligomers sample derived from clear PET flakes (hot washed and caps/label removed) with particle size of ≤700 μm from Example No. 7 was mixed with a mixture containing 5 gm caprolactone, 50 g EG, 120 mg Sb₂O₃ and 800 mg tin (II) octoate. The mixture was stirred at 800 RPM for 2 hours at room temperature to form a homogenous mixture in a 250 ml polymerization reactor equipped with a condenser, vacuum pump and inlet for nitrogen. The mixture was purged with nitrogen for 15 minutes before ramping the temperature to 285° C. Then nitrogen outlet was closed and the reaction mixture was maintained under nitrogen atmosphere at 285° C. for 4 hours. After 4 hours vacuum pulling was started to remove unreacted EG and EG vapor formed during polycondensation. After 10 hours of reaction a light brown colored adhesive renewable copolymer (CP95) was formed. The renewable copolymer did not show any adhesive like characteristics. The renewable copolymer sample was characterized for its intrinsic viscosity, molecular weight, glass transition temperature without any purification (Table 6).

TABLE 6
Glass transition temperature, molecular weight,
and intrinsic viscosity of copolymer samples.

| Renewable Copolymer | | | | | | | |
|---|---|---|---|---|---|---|---|
| samples | CP0 | CP40 | CP60-1 | CP60-2 | CP60-3 | CP80 | CP95 |
| Depolymerized-PET | 0 | 40 | 60 | 60 | — | 80 | 95 |
| oligomer product | | | | | | | |
| (wt %) | | | | | | | |
| PET flakes (g) | — | — | — | — | 60 | — | — |
| Capro-lactone (g) | 100 | 60 | 40 | — | — | 20 | 5 |
| Polycapro-lactone (g) | — | — | — | 40 | 40 | — | — |
| T_{g} (° C.) | −42 | −33 | −10.5 | −2 | — | 12 | 31 |
| Tₘ (° C.) | 58 | — | — | — | — | 154* | 215* |
| Molecular weight (Mw) | 68578 | 6456 | ND | 17653 | — | 8726 | ND |
| Intrinsic viscosity | 0.57 | 0.11 | 0.19 | 0.18 | — | 0.14 | 0.1 |
| (dL/g) | | | | | | | |
| Adhesive properties | No | Yes | Yes | Yes | Yes | Yes | No |

*Obtained from first heating cycle

### Example 24: Adhesivisity Evaluation of Renewable Copolymers

Adhesivity of the renewable copolymers obtained in the Example Nos. 20-22 was tested by measuring viscosity at 177° C., Mettler Softening Point, PAFT, and SAFT. The measurement results are summarized in the Table 7 below.

TABLE 7
The adhesivity testing results are summarized in the table below:

| Properties | CP60-3 | CP60-2 | CP80 |
|---|---|---|---|
| Viscosity @ 177° C. (cPs) | 270 | 2460 | 2940 |
| Mettler Softening Point (° C.) | 64 | 56.5 | 143 |
| PAFT (° C.) | 23 | 32 | 54 |
| SAFT (° C.) | 30 | 32 | 49 |

Viscosity measurement shows that the CP60-3 sample is much lower in viscosity than the other two samples. This suggests that this sample is lower in molecular weight than the other samples, although this also depends upon the rheology of the material. The MST testing shows that CP60-3 and CP60-2 have much lower softening points than CP80. The result that CP80 has a relatively high softening point suggests that this material has a significant crystalline component in its composition.

All three samples were tested and the results are shown above. Samples CP60-2 and CP60-3 are softer and have lower heat resistance than that of CP80. Considering samples CP60-2 and CP60-3 possess a high degree of surface tack, they can be used as an adhesive.

It should be noted that the sample CP80 has a much higher softening point and SAFT value than the other two samples, as well as a significantly higher PAFT value. The PAFT value shows that this material will maintain good adhesion to a substrate such as paper. Hence, the sample CP80 would be a good candidate to be used in hot melt adhesives. CP80 may also be used as a tackifier resin or as a polymer modifier for the use of strengthening the overall adhesive. The other two samples CP60-2 and CP60-3 could be used in adhesive applications in cold-temperature environments.

1. A process for depolymerizing a polyester comprising the steps of:
a) contacting the polyester with an aqueous metal salt solution to form a reaction mixture; and
b) heating the reaction mixture to at least 100° C. for an amount of time sufficient to depolymerize at least a portion of the polyester to a depolymerized-polyester product,
wherein the depolymerized-polyester product comprises one or more of a depolymerized-polyester monomer product and a depolymerized-polyester oligomer product, and
wherein the aqueous metal salt solution comprises from about 20% to about 90% by weight of at least one of ZnBr₂ and ZnI₂, based on the total amount of the reaction mixture.

2-41. (canceled)

42. The process according to claim 1, wherein the polyester comprises at least one of polyethylene terephthalate, polytrimethylene terephthalate, polybutylene terephthalate, polybutylene adipate terephthalate, polyethylene furanoate, polytrimethylene furanoate, polybutylene furanoate, polycarbonate, polyglycolic acid, polylactic acid, poly-2-hydroxy butyrate, polyhydroxyalkanoate, poly(3-hydroxybutyrate-co-3-hydroxyvalerate), polycaprolactone, and polybutylene succinate, clear polyethylene terephthalate, colored polyethylene terephthalate, mixed polyethylene terephthalate, clear ocean-borne polyethylene terephthalate, colored ocean-borne polyethylene terephthalate, mixed ocean-borne polyethylene terephthalate, clear river-borne polyethylene terephthalate, colored river-borne polyethylene terephthalate, mixed river-borne polyethylene terephthalate, clear lake-borne polyethylene terephthalate, colored lake-borne polyethylene terephthalate, mixed lake-borne polyethylene terephthalate, clear landfill-borne polyethylene terephthalate, colored landfill-borne polyethylene terephthalate, mixed landfill-borne polyethylene terephthalate, a PET bottle, a PET film, a PET fiber, a PET fabric, a PET flexible packaging, a PET substrate, a PET article containing a metal layer, or any mixtures thereof.

43. The process according to claim 1, wherein the polyester is in particulate form having an average particle size in a range of from about 5 μm to about 100 mm.

44. The process according to claim 1, wherein the aqueous metal salt solution comprises ocean water.

45. The process according to claim 1, wherein the aqueous metal salt solution further comprises one or more of ZnCl₂ and MgBr₂.

46. The process according to claim 1, wherein the step of heating the reaction mixture is carried out at a temperature range of from about 100° C. to about 250° C.

47. The process according to claim 1, wherein the step of heating the reaction mixture is carried out for about 1 hour to about 15 hours.

48. The process according to claim 1, wherein the depolymerized-polyester oligomer product comprises one or more oligomers having a molecular weight in a range of 166 to 3000 Da.

49. The process according to claim 1, wherein the depolymerized-polyester oligomer product comprises one or more oligomers having a glass transition temperature of greater than 15° C.

50. A composition comprising one or more of a depolymerized-polyester monomer product and a depolymerized-polyester oligomer product, obtained from the process according to claim 1, and a residual metal salt, wherein the metal salt comprises at least one of ZnBr₂ and ZnI₂.

51. A process for producing a renewable polyester comprising the steps of:
a) contacting the depolymerized-polyester product prepared according to claim 1 with a catalyst and an optional alkylene glycol, to form a polymerization feed mixture, wherein the depolymerized-polyester product comprises one or more of a depolymerized-polyester monomer product and a depolymerized-polyester oligomer product;
b) polymerizing the polymerization feed mixture by esterification and subsequent polycondensation at a temperature of at least 100° C., optionally in the presence of an inert gas, to produce the renewable polyester; and
c) removing a residual volatile organic compound, optionally in the presence of the inert gas, wherein the residual volatile organic compound comprises one or more of depolymerized-polyester monomers and the optional alkylene glycol, and
wherein the polymerization feed mixture comprises from about 30% to about 95% by weight of depolymerized-polyester product, from about 5% to about 60% by weight of the monomer, and less than 0.4% by weight of the catalyst, based on the total amount of the polymerization feed mixture.

52. The process according to claim 51, wherein the catalyst comprises antimony (III) oxide, titanium (IV) butoxide, germanium oxide, zinc acetate, or mixtures thereof.

53. The process according to claim 51, wherein the step of polymerizing is carried out under an inert gas.

54. The process according to claim 51, wherein the step of polymerizing is carried out at a temperature in a range of from about 100° C. to about 350° C.

55. The process according to claim 52, wherein the step of polymerizing is carried out for about 2 hours to about 20 hours; and wherein the step of polymerizing comprises heating the polymerization feed mixture stage-wise, including a first stage from about 1 hour to about 7 hours at a temperature in the range of from about 100° C. to about 320° C. and a second stage from about 1 hour to about 13 hours at a temperature in the range of from about 250° C. to about 350° C.

56. The process according to claim 52, wherein the renewable polyester has a glass transition temperature in the range from about 40° C. to about 85° C. and an intrinsic viscosity in the range from about 0.1 dL/g to about 0.8 dL/g.

57. A process for producing a renewable copolymer comprising the steps of:
a) contacting the depolymerized-polyester product prepared according to claim 1 with a comonomer, and with an optional alkylene glycol, to form a copolymerization feed mixture, wherein the comonomer comprises caprolactone, a caprolactone-based oligomer, a caprolactone-based polymer, or mixtures thereof;
b) heating the copolymerization feed mixture to at least about 100° C. in the presence of a ring-opening polymerization catalyst and a catalyst to form the renewable copolymer; and
c) removing one or more copolymer-residual volatile organic compounds optionally in the presence of an inert gas, wherein the one or more copolymer-residual volatile organic compounds comprises caprolactone, a caprolactone-based oligomer, the optional alkylene glycol, or mixtures thereof, and
wherein the copolymerization feed mixture comprises from about 0.1% to about 95% by weight of the depolymerized-polyester product, from about 10% to about 90% by weight of the comonomer, from about 0% to about 20% by weight of the optional alkylene glycol, less than about 2% by weight of the catalyst, and less than about 2% by weight of ring-opening polymerization catalyst, based on the total amount of the copolymerization feed mixture.

58. The process according to claim 57, wherein the ring-opening polymerization catalyst comprises tin (II) octoate, aluminum alkoxides, zinc oxide, 1,5,7-triazabicyclo [4.4.0] dec-5-ene, 1,8-triazabicyclo [5.4.0]-undec-7-ene, or mixtures thereof, and
wherein the catalyst comprises antimony (III) oxide, titanium (IV) butoxide, germanium oxide, zinc acetate or mixtures thereof.

59. The process according to claim 57, wherein the renewable copolymer has at least one of the following properties:
(i) peel adhesion failure temperature of at least 20° C., as measured according to a modified ASTM 4498 method, and
(ii) a shear adhesion failure temperature of at least 25° C., as measured according to ASTM 4498 method.

60. A process for producing renewable polyamides, polyurethanes, epoxy polymers, ring-opening polymers using the depolymerized-polyester product prepared according to claim 1 as a feedstock.
